(19) United States
(12) Patent Application Publication
(10) Pub. No.: US 2026/0289734 A1
(43) Pub. Date: Sep. 24, 2026

(54) IMAGE DATA PROCESSING DEVICE, IMAGE DATA PROCESSING METHOD, IMAGE DATA PROCESSING PROGRAM, IMAGING APPARATUS, AND LEARNING DEVICE

(71) Applicant: FUJIFILM Corporation, Tokyo (JP)

(72) Inventors: Ryo HASEGAWA, Saitama-shi (JP); Koichi TANAKA, Saitama-shi (JP); Hitoshi SAKURABU, Saitama-shi (JP); Ryosuke NAGAMI, Saitama-shi (JP)

(73) Assignee: FUJIFILM Corporation, Tokyo (JP)

(21) Appl. No.: 19/685,161

(22) Filed: May 22, 2026

Related U.S. Application Data
(63) Continuation of application No. PCT/JP2024/039751, filed on Nov. 8, 2024.

(30) Foreign Application Priority Data
Nov. 30, 2023 (JP) 2023-203452

(51) Int. Cl. G06T 5/50; G06T 5/60

(52) U.S. Cl. CPC G06T 5/50; G06T 5/60; G06T 2207/20081

(57) ABSTRACT

Provided are an image data processing device, an image data processing method, an image data processing program, an imaging apparatus, and a learning device capable of generating distance image data having high accuracy. The image data processing device includes at least one processor. The processor is configured to acquire first image data captured through an optical system. The processor is configured to correct image quality degradation caused by the optical system to generate second image data from the first image data. The processor is configured to generate first distance image data from the second image data.

### CROSS-REFERENCE TO RELATED APPLICATIONS

The present application is a Continuation of PCT International Application No. PCT/JP2024/039751 filed on Nov. 8, 2024 claiming priority under 35 U.S. C § 119(a) to Japanese Patent Application No. 2023-203452 filed on Nov. 30, 2023. Each of the above applications is hereby expressly incorporated by reference, in its entirety, into the present application.

### BACKGROUND OF THE INVENTION

### 1. Field of the Invention

The present invention relates to an image data processing device, an image data processing method, an image data processing program, an imaging apparatus, and a learning device, and particularly relates to an image data processing device, an image data processing method, an image data processing program, an imaging apparatus, and a learning device that generate distance image data.

### 2. Description of the Related Art

A technique of measuring a distance from one piece of image data captured by one camera by using artificial intelligence (AI) is known (for example, JP2022-129941A and JP2020-148483A).

### SUMMARY OF THE INVENTION

One embodiment according to the disclosed technology provides an image data processing device, an image data processing method, an image data processing program, an imaging apparatus, and a learning device that can generate distance image data having high accuracy.
(1) An image data processing device comprising at least one processor, in which the processor is configured to: acquire first image data captured through an optical system; generate second image data from the first image data by correcting image quality degradation caused by the optical system; and generate first distance image data from the second image data.
(2) The image data processing device according to (1), in which the processor is configured to: generate the second image data from the first image data by correcting image quality degradation that affects generation of the first distance image data among the image quality degradation caused by the optical system.
(3) The image data processing device according to (1) or (2), in which the processor is configured to: generate third image data from the first image data; and output the third image data to a display destination or a recording destination.
(4) The image data processing device according to (3), in which the processor is configured to: generate the third image data from the first image data by performing correction different from correction performed on the second image data.
(5) The image data processing device according to any one of (1) to (4), in which the processor is configured to: generate fourth image data from the first image data; output the fourth image data to a display destination or a recording destination; generate second distance image data from the first distance image data by performing processing of reducing a difference generated between the first distance image data and the fourth image data; and output the second distance image data to a display destination or a recording destination.
(6) The image data processing device according to any one of (1) to (5), in which the processor is configured to: output the first distance image data to a display destination or a recording destination; generate fifth image data from the first image data; generate sixth image data from the fifth image data by performing processing of reducing a difference generated between the first distance image data and the fifth image data; and output the sixth image data to a display destination or a recording destination.
(7) The image data processing device according to (3), in which the processor is configured to: output the second image data to a recording destination in association with the third image data.
(8) The image data processing device according to (7), in which the processor is configured to: output information used for generating the second image data to a recording destination in association with the second image data.
(9) The image data processing device according to (1) to (8), in which the processor is configured to: acquire first information including information necessary for correction of the image quality degradation caused by the optical system; and generate the second image data based on the first information.
(10) The image data processing device according to (9), in which the processor is configured to: provide a notification in a case where the first information is not acquired.
(11) The image data processing device according to (9) or (10), in which the processor is configured to: generate the second image data in a case where specific information among a plurality of pieces of information included in the first information is acquired.
(12) The image data processing device according to any one of (9) to (11), in which the processor is configured to: restrict generation of the second image data in a case where the first information is not acquired.
(13) The image data processing device according to any one of (9) to (12), in which the processor is configured to: generate the second image data based on second information specified in advance, in a case where the first information is not acquired; and notify that the second image data is generated based on the second information.
(14) The image data processing device according to any one of (1) to (13), in which the processor is configured to: generate the second image data by using one of components of the first image data or mixed image data in which the components are weighted.
(15) The image data processing device according to any one of (1) to (14), in which the processor is configured to: generate the second image data by using a component that expresses luminance most effectively among the components of the first image data.
(16) The image data processing device according to any one of (1) to (15), in which the processor is configured to: generate the second image data for each component of the first image data; and generate the first distance image data for each component from the second image data for each component.
(17) The image data processing device according to any one of (1) to (16), in which the processor is configured to: generate the first distance image data from the second image data by using a trained model generated through machine learning.
(18) An image data processing method comprising: acquiring first image data captured through an optical system; generating second image data from the first image data by correcting image quality degradation caused by the optical system; and generating first distance image data from the second image data.
(19) An image data processing program causing a computer to implement: a function of acquiring first image data captured through an optical system; a function of generating second image data from the first image data by correcting image quality degradation caused by the optical system; and a function of generating first distance image data from the second image data.
(20) An imaging apparatus comprising: an imaging unit that captures image data through an optical system; and the image data processing device according to any one of (1) to (17) that processes the image data captured by the imaging unit. (21) The imaging apparatus according to (20), further comprising: a main body that includes the imaging unit and the image data processing device; and an interchangeable lens that includes the optical system and is attachably and detachably mounted on the main body to be communicable with the main body, in which the processor is configured to: acquire lens information from the interchangeable lens mounted on the main body; and generate the second image data based on the lens information.
(22) A learning device comprising at least one processor, in which the processor is configured to: acquire a data set including image data for learning, which is captured through an optical system and of which image quality degradation caused by the optical system is corrected, and ground-truth data corresponding to the image data for learning; and generate a model that outputs distance image data in a case where image data is input, by performing machine learning by using the data set.

### BRIEF DESCRIPTION OF THE DRAWINGS

FIG. 1 is a diagram showing an example of a system configuration of a lens-interchangeable digital camera.

FIG. 2 is a schematic diagram of a hardware configuration of a digital camera.

FIG. 3 is a block diagram of main functions of the digital camera related to distance measurement.

FIG. 4 is a block diagram of main functions of a development treatment unit.

FIG. 5 is a conceptual diagram of learning of a model.

FIG. 6 is a flowchart showing a procedure of distance measurement.

FIGS. 7A and 7B are diagrams showing an example of visualization of distance image data.

FIG. 8 is a block diagram of main functions of the digital camera related to live view output and distance measurement.

FIG. 9 is a flowchart showing a procedure of processing of live view output and distance measurement.

FIG. 10 is a block diagram of main functions of the digital camera related to live view output and distance measurement.

FIG. 11 is a flowchart showing a processing procedure of output of live view.

FIG. 12 is a diagram showing a flow of processing until a live view image and a distance image are generated.

FIG. 13 is a block diagram of main functions of the digital camera related to live view output and distance measurement.

FIG. 14 is a flowchart showing a processing procedure of output of live view.

FIG. 15 is a diagram showing a flow of processing until a live view image and a distance image are generated.

FIG. 16 is a block diagram of main functions of the digital camera related to recording of image data obtained by imaging.

FIG. 17 is a flowchart showing a processing procedure in a case of recording image data.

### DESCRIPTION OF THE PREFERRED EMBODIMENTS

Hereinafter, preferred embodiments of the present invention will be described in detail with reference to the accompanying drawings.

### First Embodiment

With the progress of deep learning, a technology (monocular camera distance measurement technology) of measuring a distance by AI from one image data captured by one camera has attracted attention.

In the distance measurement using AI, machine learning of a model is performed using actually captured image data by the camera.

Meanwhile, in an image captured by the camera, image quality degradation such as distortion, color shading, and edge part light reduction occurs due to an optical system. The appearance of the image quality degradation varies depending on the lens. For example, even in a case of lenses having the same focal length, the lenses may have different distortion characteristics depending on differences in optical design (a combination of positive and negative lenses, the number of lenses, a material of the lens, and the like). Therefore, in a case where a lens different from a lens used during learning is used, the accuracy of the distance measurement may be reduced.

As one method of solving this problem, there is a method of preparing image data captured by all lenses existing in the world and training a model using all of the image data. However, this method is not practical. In addition, even in a case where the image data can be prepared, there is a problem in that a large amount of time is required for learning. Further, there is also a disadvantage in that the lens that is sold or the like after the model is generated cannot be supported.

Therefore, in the present embodiment, an image data processing device, a method, and a program that can perform distance measurement with high accuracy from image data captured by a lens different from a lens used during learning in distance measurement using AI will be described.

### Lens-interchangeable Digital Camera

Here, a case where the present invention is applied to a lens-interchangeable digital camera will be described as an example. The lens-interchangeable digital camera refers to a digital camera capable of lens interchange.

The lens-interchangeable digital camera of the present embodiment is a digital camera comprising a distance measurement function. That is, the lens-interchangeable digital camera is a digital camera comprising a function of measuring a distance from captured image data.

A distance measurement result is acquired in a form of distance image data. The distance image data is image data in which a pixel value of each pixel is composed of distance information to a subject. The pixel value of each pixel of the distance image data represents distance information of a corresponding pixel in the captured image data. Since the distance information of each pixel is disposed corresponding to a position of each pixel of the captured image data, the distance image data is also referred to as distance map data, depth map data, or the like. The distance image data is visualized, for example, by expressing a distance value in each pixel in a color or a density.

### System Configuration

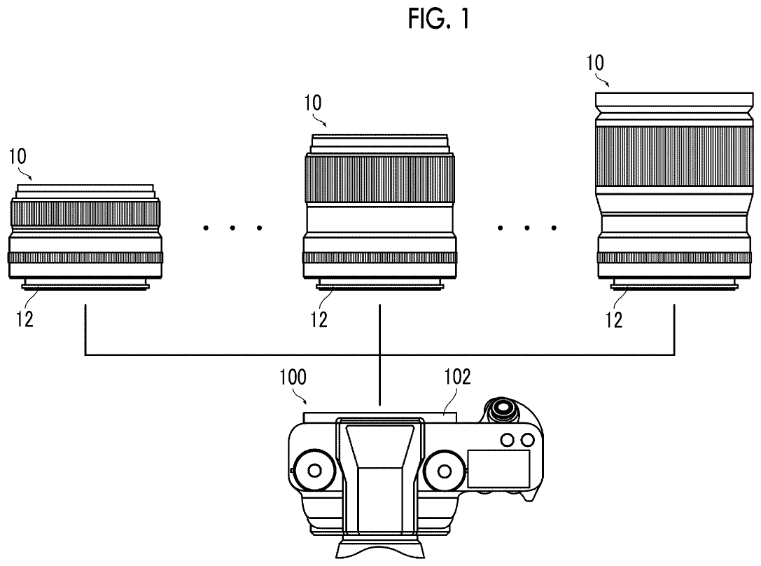

FIG. 1 is a diagram showing an example of a system configuration of a lens-interchangeable digital camera. In particular, FIG. 1 shows an example of a system configuration in a mirrorless single-lens camera. The mirrorless single-lens camera is one of classifications of a digital camera and is a lens-interchangeable digital camera of a type in which an image is checked through an electronic viewfinder (EVF) or a rear surface monitor instead of an optical finder in a single-lens reflex camera. Here, the description will be made using an example of the mirrorless single-lens camera, but the present invention can also be applied to a single-lens reflex camera.

A camera system of the lens-interchangeable digital camera comprises at least one interchangeable lens 10 and at least one camera body 100. FIG. 1 shows an example of a case where the camera system is composed of a plurality of interchangeable lenses 10 and one camera body 100.

Each interchangeable lens 10 is composed of a lens having a different specification. For example, the interchangeable lens 10 is composed of a lens having a different focal length, a different open F number, a different zoom magnification, and the like.

Each interchangeable lens 10 is attachably and detachably mounted on the camera body 100 via a mount. The camera body 100 comprises a camera-side mount 102 for mounting the interchangeable lens 10. In addition, each interchangeable lens 10 comprises a lens-side mount 12 for mounting on the camera body 100.

The camera-side mount 102 and the lens-side mount 12 each comprise a plurality of terminals (not shown). In a case where the interchangeable lens 10 is mounted on the camera body 100, corresponding terminals are connected to each other. Accordingly, the camera body 100 and the interchangeable lens 10 are communicably connected to each other.

The interchangeable lens 10 is mounted on the camera body 100 to configure a digital camera 1 as an imaging apparatus. The digital camera 1 is configured as a monocular imaging apparatus (monocular camera).

### Hardware Configuration of Digital Camera

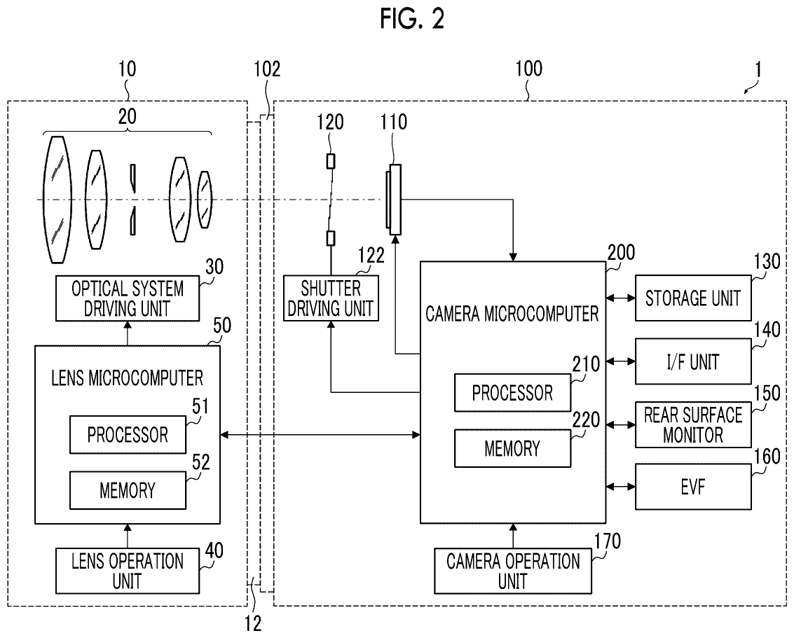

FIG. 2 is a schematic diagram of a hardware configuration of the digital camera.

### Interchangeable Lens

The interchangeable lens 10 includes an optical system 20, an optical system driving unit 30, a lens operation unit 40, a lens microcomputer 50, and the like.

The optical system 20 is composed of a combination of a plurality of lenses. In addition, the optical system 20 comprises a stop. The stop is composed of using, for example, an iris stop.

The optical system driving unit 30 comprises a focus drive unit, a stop drive unit, and the like. The focus driving unit drives a lens group for focus adjustment (focus lens group). The stop driving unit drives the stop. In a case where the interchangeable lens 10 has an optical camera shake-correction function, the optical system driving unit 30 further comprises a camera shake-correction drive unit. The camera shake-correction drive unit drives a lens for camera shake-correction. In addition, in a case where the interchangeable lens 10 is a zoom lens, the optical system driving unit 30 may include a zoom drive unit. The zoom drive unit drives a lens group (zoom lens group) for zoom.

The lens operation unit 40 includes a focus operation unit, a stop operation unit, and the like. The focus operation unit includes a focus operation member (for example, a focus ring) and a sensor that detects an operation on the focus operation member. The stop operation unit includes a stop operation member (for example, a stop ring) and a sensor that detects an operation on the stop operation member. In a case where the interchangeable lens 10 is a zoom lens, the lens operation unit 40 further comprises a zoom operation unit. The zoom operation unit includes a zoom operation member (for example, a zoom ring) and a sensor that detects an operation on the zoom operation member.

The lens microcomputer 50 is composed of a microcomputer comprising a processor 51, a memory 52, and the like.

The processor 51 is composed of, for example, a central processing unit (CPU) that is a general-purpose processor functioning as various processing units by executing a program. The processor 51 functions as a controller that comprehensively controls the operation of the interchangeable lens 10 by executing a predetermined program.

The memory 52 includes a random-access memory (RAM), a read-only memory (ROM), an electrically erasable programmable read only memory (EEPROM), and the like. The memory 52 stores various data necessary for the processor 51 to execute the program and perform the control.

### Camera Body

The camera body 100 comprises an image sensor 110, a shutter 120, a storage unit 130, an interface unit (I/F unit) 140 (I/F: interface), a rear surface monitor 150, an EVF 160, a camera operation unit 170, a camera microcomputer 200, and the like.

The image sensor 110 receives light passing through the interchangeable lens 10 and captures an optical image of a subject. In the present embodiment, the image sensor 110 is an example of an imaging unit.

The image sensor 110 is composed of a color image sensor having a predetermined color filter array (CFA). The configuration of the image sensor 110 is not particularly limited. A complementary metal oxide semiconductor (CMOS) type, a charge-coupled device (CCD) type, or the like can be employed.

For example, in the present embodiment, a CMOS type color image sensor comprising a driving unit and a signal processing unit is employed as the image sensor 110. Therefore, a signal (image signal) of each pixel is driven and read out by a built-in driving unit. The image signal read out from each pixel is subjected to predetermined signal processing by the signal processing unit and is output from the image sensor 110. The signal processing unit includes, for example, a correlated double sampling (CDS) circuit, an automatic gain control (AGC) circuit, an analog to digital (A/D) converter, and the like. The CDS circuit removes reset noise included in the image signal. The AGC circuit amplifies the image signal and controls the image signal to have a certain level of magnitude. The A/D converter converts the analog image signal into a digital image signal. The image signal read out from each pixel is finally converted into a digital signal and is output from the image sensor 110.

An arrangement of color filters in the image sensor 110 is not particularly limited. For example, in the present embodiment, a Bayer array is employed. In the Bayer array, four pixels are grouped together, and a red (R) color filter is assigned to one pixel, a green (G) color filter is assigned to two pixels, and a blue (B) color filter is assigned to one pixel, and the color filters are regularly arranged. In addition, for example, X-Trans (registered trademark) or the like can also be employed as the color filter arrangement.

The shutter 120 is composed of, for example, a focal plane shutter. The shutter 120 is operated by being driven by the shutter driving unit 122. The shutter driving unit 122 includes a charging motor, a holding electromagnet, a drive circuit thereof, and the like.

The storage unit 130 mainly stores the image data obtained by imaging. The storage unit 130 includes a storage device, a control circuit thereof, and the like. The storage device is composed of, for example, an EEPROM and a solid state drive (SSD). The storage device may be configured to be provided integrally with the camera body 100 (so-called built-in memory form) or may be configured to be attachable to and detachable from the camera body 100 (so-called memory card form). In a case where the storage unit 130 is configured to be attachable to and detachable from the camera body 100, the camera body 100 comprises a mounting portion (so-called card slot) for a memory card as the storage device. The storage unit 130 is an example of a recording destination in the digital camera 1.

The interface unit 140 connects the camera body 100 and an external apparatus to each other to enable communication therebetween. The interface unit 140 comprises various connection terminals such as a universal serial bus (USB) terminal and a high-definition multimedia interface (HDMI) terminal. In a case where an external storage (so-called external storage device) is connected to the digital camera 1 via the interface unit 140, the external storage is another example of the recording destination. In addition, in a case where an external display (so-called external display) is connected to the digital camera 1 via the interface unit 140, the external display is an example of the display destination.

The rear surface monitor 150 is a relatively large monitor provided on a rear surface of the camera body 100. The rear surface monitor 150 includes a display, a drive circuit thereof, and the like. The display is composed of, for example, a liquid crystal display (LCD) and an organic EL display (organic light emitting diode display, OLED display). The rear surface monitor 150 can also be configured by a touch panel. The rear surface monitor 150 is an example of the display destination in the digital camera 1.

The EVF 160 has a small monitor, and has a structure for observing the display of the monitor through the finder. The EVF 160 is another example of the display destination in the digital camera 1.

The camera operation unit 170 includes various operation members provided in the camera body 100, a sensor that detects an operation on the operation members, and the like. The operation members include a power button, a shutter button, a mode dial, a cross button, an OK button, a cancel button, and the like. In addition, in a case where the rear surface monitor 150 is composed of a touch panel, the operation members include the touch panel.

The camera microcomputer 200 is composed of a microcomputer comprising a processor 210, a memory 220, and the like. The microcomputer is an example of a computer.

The processor 210 is composed of, for example, a CPU that is a general-purpose processor functioning as various processing units by executing a program. The processor 210 functions as a controller that comprehensively controls the operation of the digital camera 1 by executing a predetermined program. In addition, the processor 210 functions as an image data processing unit that processes image data obtained by imaging by executing a predetermined program.

The memory 220 includes a RAM, a ROM, an EEPROM, and the like. The memory 220 stores various types of data necessary for the processor 210 to execute a program, control, and the like.

The camera microcomputer 200 is communicably connected to the lens microcomputer 50 by mounting the interchangeable lens 10 on the camera body 100.

### Functions of Digital Camera

### Basic Functions

The digital camera 1 has an imaging function and a playback function as basic functions.

### Imaging Function

The imaging function is a function of capturing an image. The image includes both a still image and a video. The user selects any one of the still image or the motion picture and issues an instruction to execute the imaging. The processor 210 of the camera body 100 executes imaging control in response to the imaging instruction and captures an image for recording. In addition, the processor 210 executes recording control to record image data obtained by the imaging. The imaging control includes auto focus (AF) control, automatic exposure (AE) control, and the like.

The image data obtained by the imaging is converted into image data in a predetermined format and recorded in the storage unit 130. For example, the image data is converted into image data in a joint photographic experts group (JPEG) format and recorded in the storage unit 130. The processor 210 of the camera body 100 processes a signal output from the image sensor 110 to generate image data in a predetermined format and records the image data in the storage unit 130.

In addition, the image data obtained by the imaging is recorded in the storage unit 130 in a RAW data format as necessary. The RAW data is unprocessed (undeveloped) sensor data output from the image sensor 110.

In a case of the imaging, a live view (through-image) is displayed on the rear surface monitor 150 or the EVF 160. That is, the video captured by the image sensor 110 is displayed on the rear surface monitor 150 or the EVF 160. The processor 210 of the camera body 100 processes the signal output from the image sensor 110 to generate image data for the live view and outputs the image data to the rear surface monitor 150 or the EVF 160.

### Playback Function

The playback function is a function of displaying the recorded image on the rear surface monitor 150 or the EVF 160 in a playback manner. The processor 210 of the camera body 100 reads out the image data recorded in the storage unit 130 in response to a playback instruction from the user and outputs the image data to the rear surface monitor 150 or the EVF 160.

### Distance Measurement Function

As described above, the digital camera 1 of the present embodiment comprises the function (distance measurement function) of measuring the distance from the captured image data (monocular image data). The distance measurement is performed using the AI. That is, the distance measurement is performed using the trained model that has been trained by machine learning to output the corresponding distance image data in a case where the image data obtained by imaging the subject is input. In the digital camera 1 of the present embodiment, the image data is normalized or standardized by performing predetermined image processing on the image data to be measured before the image data is input to the trained model, and thus high-accuracy distance measurement (generation of the distance image data) is enabled. Specifically, as the pre-processing, the processing of correcting the image quality degradation caused by the optical system (image quality degradation caused by the characteristics of the interchangeable lens) is performed to normalize or standardize the image data. That is, the image quality of the image data to be input to the trained model is made uniform by removing the image quality degradation caused by the optical system, and thus the accuracy of the distance measurement is improved.

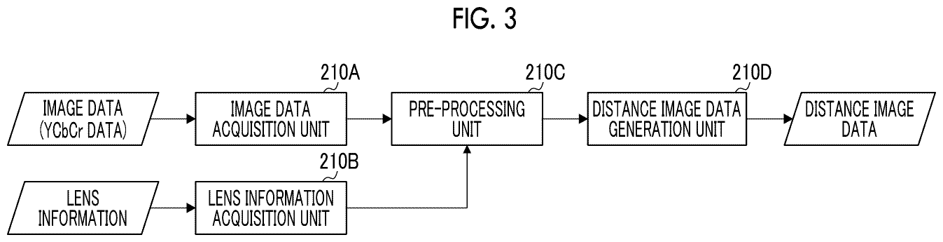

FIG. 3 is a block diagram of main functions of the digital camera related to the distance measurement.

As shown in FIG. 3, the digital camera 1 has functions of an image data acquisition unit 210A, a lens information acquisition unit 210B, a pre-processing unit 210C, a distance image data generation unit 210D, and the like related to the distance measurement. The functions of the units are implemented by the processor 210 of the camera body 100. The processor 210 implements the functions of the units by executing a predetermined program (image data processing program).

### Image Data Acquisition Unit

The image data acquisition unit 210A acquires the image data to be processed. The image data to be processed is the image data for distance measurement. In the present embodiment, the image data after so-called development treatment is acquired as the image data for distance measurement. For example, image data (YCbCr data) in a YCbCr format is acquired. The image data in the YCbCr format is image data consisting of luminance data Y representing luminance and color difference data Cb and Cr representing differences between two colors and the luminance. One color difference data Cb of the two color difference data Cb and Cr represents a difference (B-Y) between a blue color component and the brightness, and the other color difference data Cr represents a difference (R-Y) between a red color component and the brightness.

### Development Treatment

The development treatment is performed by the processor 210 of the camera body 100. The processor 210 functions as a development treatment unit 210E by executing a predetermined program.

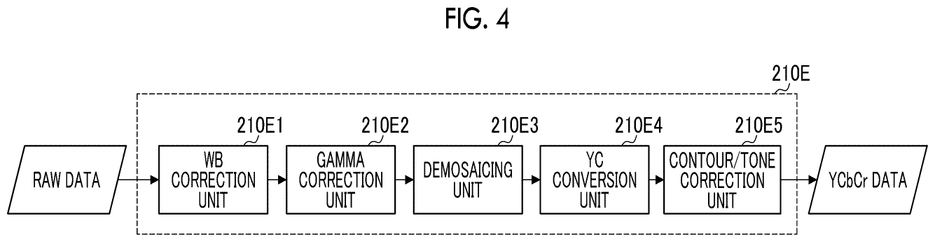

FIG. 4 is a block diagram of main functions of the development treatment unit.

The development treatment unit 210E has functions of a white balance correction unit (WB correction unit) 210E1 (WB: white balance), a gamma correction unit 210E2, a demosaicing unit 210E3, a YC conversion unit 210E4, a contour/tone correction unit 210E5, and the like.

The development treatment unit 210E performs development treatment on image data (RAW data) output from the image sensor 110 to generate image data (YCbCr data) in a YCbCr format.

In the image data (RAW data) output from the image sensor having the Bayer array adopting the primary color filter, each pixel is composed of monochromatic data of any of R, G, or B.

The white balance correction unit 210E1 performs white balance correction on the image data (RAW data) output from the image sensor 110. The white balance correction is performed by multiplying a gain value for white balance correction for each of the data of R, G, and B. The gain value for white balance correction is set based on the light source type. The light source type is specified by, for example, analyzing the RAW data. Alternatively, the user manually selects the light source type.

The gamma correction unit 210E2 performs gamma correction on the image data after the white balance correction. The gamma correction is performed by using, for example, a look-up table (LUT). For example, the gamma correction is performed by referring to the LUT having input-output characteristics for gamma correction and reading out the output data corresponding to the input data from the LUT.

The demosaicing unit 210E3 performs demosaicing processing on the image data after the gamma correction. The demosaicing processing is processing of storing a missing color component in each pixel in a digital camera adopting a single-plate image sensor having a predetermined color filter array. The demosaicing unit 210E3 interpolates the data of the missing color component in each pixel by using information of an edge part pixel. The demosaicing processing generates image data (image data of color components consisting of R, G, and B) in which the data of R, G, and B are aligned in each pixel.

The YC conversion unit 210E4 performs processing (RGB/YC conversion processing) of converting the image data (RGB data) after the demosaicing into image data (YCbCr data) consisting of the brightness data Y and the color difference data Cb and Cr. The YC conversion unit 210E4 converts the R, G, and B data of each pixel into the brightness data Y and the color difference data Cb and Cr by using, for example, a predetermined conversion formula. The conversion formula is composed of, for example, a formula in which each data of R, G, and B is multiplied by a predetermined coefficient and added. Therefore, the generated brightness data Y and color difference data Cb and Cr are composed of data in which each data of R, G, and B is weighted and mixed.

In the present embodiment, the image data (YCbCr data) after the YC conversion is an example of first image data.

The contour/tone correction unit 210E5 performs processing (edge enhancement processing) of emphasizing an edge part (a portion having a large brightness change) on the brightness data Y and performs tonal correction processing of realizing good color reproduction on the color difference data Cb and Cr. The tonal correction is performed by, for example, matrix operation using a predetermined color correction matrix.

As described above, in the digital camera 1 of the present embodiment, the white balance correction, the gamma correction, the demosaicing, the RGB/YC conversion processing, the edge enhancement processing, the tonal correction processing, and the like are performed as the development treatment. The development treatment unit 210E performs the development treatment on the image data (RAW data) output from the image sensor 110 to generate the image data (YCbCr data) in a YCbCr format consisting of the brightness data Y and the color difference data Cb and Cr.

The image data acquisition unit 210A acquires the image data (YCbCr data) subjected to the development treatment and adds the image data to the pre-processing unit 210C.

### Lens Information Acquisition Unit

The lens information acquisition unit 210B acquires the lens information of the interchangeable lens 10 mounted on the camera body 100.

The lens information is information indicating specifications of the interchangeable lens. The lens information includes, for example, lens model data, lens characteristic data, lens characteristic correction data, and the like.

The lens model data is data representing main specifications of the interchangeable lens. The lens model data includes a lens model name, a focal length, an open F number, a manufacturer name, and the like.

The lens characteristic data is data indicating characteristics of the interchangeable lens. The lens characteristic data includes brightness shading data, color shading data, distortion data, aberration data, and the like.

The lens characteristic correction data is data for correcting image quality degradation (distortion, color shading, edge part light reduction, and the like) caused by the characteristics of the interchangeable lens. The lens characteristic correction data includes brightness shading correction data, color shading correction data, distortion correction data, aberration correction data, and the like.

Here, the brightness shading is a phenomenon in which brightness is decreased as a distance from a center (optical axis) is increased in a case where a surface having uniform brightness is imaged. The brightness shading is also referred to as edge part light reduction, peripheral light amount drop, and the like. The brightness shading changes depending on conditions of the lens (focal length, F number, and the like).

The brightness shading correction refers to correcting the brightness shading by image processing. The brightness shading correction data is data required for the brightness shading correction.

The color shading is a phenomenon in which an intensity ratio of signals of respective colors varies depending on a location in a case where a surface having uniform brightness is imaged, and is recognized as color shading. The color shading changes in an amount of occurrence depending on a difference in incidence angle of a ray in a light-receiving surface, and the amount of occurrence of the color shading is increased as the difference in the incidence angle is increased. Since a distribution of the incidence direction of the ray also changes depending on the conditions of the lens (focal length, F number, and the like), the color shading also changes depending on the conditions of the lens.

The color shading correction refers to correcting the color shading by image processing. The color shading correction data is data required for the color shading correction.

The distortion refers to a phenomenon in which distortion occurs in a focal plane and a straight line is not depicted as a straight line. The distortion is also referred to as a distortion aberration or an image plane distortion. The distortion appears in an image as a barrel distortion, a pincushion distortion, or the like depending on a manner of distortion.

The distortion correction refers to correcting the distortion by image processing. The distortion correction data is data required for the distortion correction.

The aberration data includes information on various aberrations (lateral chromatic aberration or the like) that occur due to the characteristics of the interchangeable lens. The aberration correction refers to correcting various aberrations that occur due to the optical characteristics of the interchangeable lens by image processing. The aberration correction data is data required for the aberration correction.

The lens information is stored in the memory 52 of the lens microcomputer 50 (for example, stored in the ROM or the EEPROM).

The processor 210 of the camera body 100 communicates with the processor 51 of the interchangeable lens 10 to acquire the lens information from the processor 51 of the interchangeable lens 10. The lens information is acquired in a case of power-on of the camera body 100 and in a case of lens exchange.

The lens information acquisition unit 210B adds the lens information acquired from the interchangeable lens 10 to the pre-processing unit 210C.

In the present embodiment, the information included in the lens information is an example of information required for correcting the image quality degradation caused by the optical system. In addition, the lens information is an example of first information.

### Pre-Processing Unit

The pre-processing unit 210C performs predetermined image processing on the image data for distance measurement to correct the image quality degradation caused by the optical system. That is, the image quality degradation caused by the characteristics of the interchangeable lens used for capturing the image data for distance measurement is corrected. In the present embodiment, the image data for distance measurement is corrected by using the lens characteristic correction data included in the lens information acquired by the lens information acquisition unit 210B.

As described above, the lens characteristic correction data is data for correcting the image quality degradation caused by the optical characteristics of the interchangeable lens. The lens characteristic correction data includes brightness shading correction data, color shading correction data, distortion correction data, aberration correction data, and the like. The pre-processing unit 210C corrects the image data for distance measurement by using the lens characteristic correction data. That is, the brightness shading, the color shading, the distortion, the aberration, and the like are corrected by the image processing by using the lens characteristic correction data. Since this type of correction technique is well known, the detailed description thereof will be omitted.

### Distance Image Data Generation Unit

The distance image data generation unit 210D performs the distance measurement by performing the image analysis on the image data for distance measurement and generates the distance image data. In the present embodiment, the distance image data is generated from the image data for distance measurement by using a trained model (hereinafter, referred to as “distance image data generative AI”) generated by machine learning.

The distance image data generative AI is generated by performing machine learning on a model such that the distance image data is output from the image data captured through the optical system.

The distance image data generative AI is generated by applying, for example, a known machine learning algorithm such as a neural network. The neural network includes, for example, a convolutional neural network (CNN), a fully connected neural network, and a recurrent neural network.

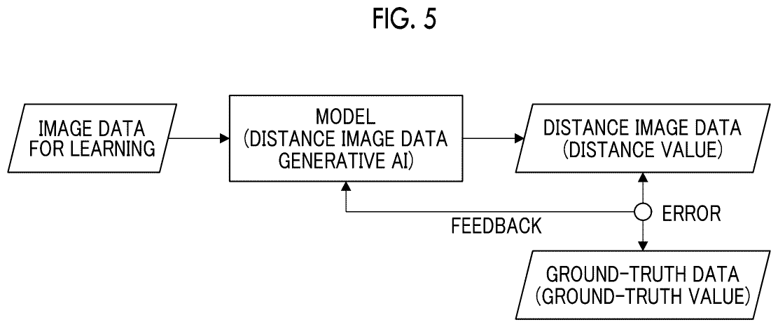

FIG. 5 is a conceptual diagram of the learning of the model.

The learning of the model is performed, for example, by inputting the image data for learning (image data for learning) to the model and feeding back an error between a predicted distance value and a ground-truth value (ground-truth label) to the model. The ground-truth value is an actual distance to the subject included in the image data for learning. The feedback means updating a parameter (for example, a weight coefficient) of the model such that the error is reduced.

The generation of the distance image data generative AI is performed by using a learning device. The learning device is composed of, for example, a computer. That is, the computer functions as the learning device by executing a predetermined program. The computer constituting the learning device has a configuration comprising at least a processor and a memory. As an example, the computer constituting the learning device has a configuration comprising a processor, a memory, an auxiliary storage device, an output device, and an input device.

The learning device performs the learning of the model constituting the distance image data generative AI by using a predetermined data set (data set for learning). The data set for learning is composed of a set of predetermined image data (image data for learning) and ground-truth data thereof.

The image data for learning is composed of, for example, an image captured by a digital camera. That is, the image data for learning is composed of image data captured by an image sensor via an optical system.

The ground-truth data is data indicating a ground-truth value of the corresponding image data for learning. In the present embodiment, the ground-truth value is data of a distance to a subject (subject distance) included in the corresponding image data for learning. Therefore, the ground-truth data is composed of data of a distance for each pixel to the subject included in the corresponding image data for learning.

The device (digital camera) that captures the image data for learning is not particularly limited. Therefore, it is not necessary to use an imaging apparatus having the same configuration as the imaging apparatus planned to be equipped with the distance image data generative AI. However, the image data used for the image data for learning is image data in a state in which there is almost no image quality degradation caused by the optical system, particularly, image quality degradation that affects the distance measurement.

In the image data for learning, a method of suppressing the image quality degradation caused by the optical system is not particularly limited. In a case where a lens (so-called lens in which distortion, color shading, edge part light reduction, and the like are corrected by lens design) in which there is almost no image quality degradation caused by the optical system is used, the image data obtained by the imaging can be used as the image data for learning as it is. On the other hand, in a case where a lens in which the image quality degradation caused by the optical system occurs is used, the image data obtained by the imaging is subjected to image processing to correct the image quality degradation caused by the optical system.

As described above, in the present embodiment, the image quality degradation caused by the optical system is corrected, and the image data for distance measurement is input to the distance image data generative AI. Therefore, even in the learning stage, the machine learning of the model is performed using the image data (optically ideal image data) in which there is almost no image quality degradation.

The generated distance image data generative AI is stored in the memory 220 of the camera microcomputer 200. The processor 210 that functions as the distance image data generation unit 210D generates the distance image data from the image data for distance measurement by using the distance image data generative AI stored in the memory 220. That is, the image data for distance measurement is input to the distance image data generative AI, and the distance image data output as the processing result is acquired.

### Distance Measurement (Generation of Distance Image Data)

Next, a distance measurement method (method for generating distance image data) by the digital camera 1 of the present embodiment will be described.

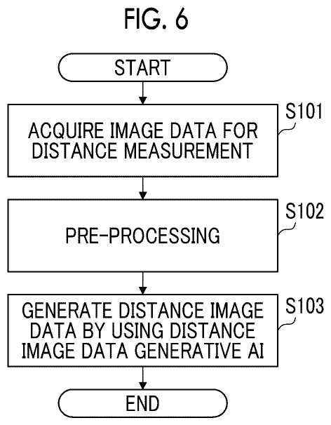

FIG. 6 is a flowchart showing a procedure of the distance measurement. The procedure of the distance measurement shown in FIG. 6 is an example of the image data processing method.

First, the image data for distance measurement is acquired (step S101). In the present embodiment, the image data for distance measurement is image data obtained by imaging and is image data after the development treatment. In the present embodiment, image data (YCbCr data) in a YCbCr format is acquired as the image data after the development treatment.

Next, the acquired image data for distance measurement is subjected to the pre-processing (step S102). The pre-processing is processing of performing predetermined image processing on the image data for distance measurement to correct the image quality degradation caused by the optical system. In the present embodiment, the image processing is performed using the lens information of the interchangeable lens 10 that has captured the image data to correct the image quality degradation caused by the optical system. It should be noted that the lens information is acquired in advance.

Next, the distance image data is generated from the image data for distance measurement after the pre-processing by using the distance image data generative AI (step S103). That is, the image data after the pre-processing is input to the distance image data generative AI, and the distance image data output as the processing result is acquired.

Here, as described above, the distance image data generative AI of the present embodiment is generated by using the image data in a state in which the image quality degradation caused by the optical system is almost not present for learning. In the digital camera 1 of the present embodiment, the image data for distance measurement is input to the distance image data generative AI after the image quality degradation caused by the optical system is corrected. Accordingly, the distance image data having high accuracy can be acquired by eliminating the influence of the optical system. In addition, even in a case where the lens is exchanged, the distance image data having high accuracy can be stably acquired.

The generated distance image data is used for a purpose. For example, the distance image (distance map) is visualized and output to the display destination (rear surface monitor 150 or EVF 160). For example, in a case where the distance image data is generated from the image data captured for display or recording, and the visualized distance image is displayed together with the captured image, the distance image can be displayed in a superimposed manner on the captured image (so-called superimposition display). In the superimposition display, for example, the distance image is displayed in a semi-transparent manner. In addition, the captured image and the distance image can be displayed in parallel. In addition, for example, the distance image data is recorded in a predetermined format in the recording destination (storage unit 130). For example, the distance image data is recorded in the recording destination in association with the captured image data (image data for recording). In addition, the distance image data can also be used for AF.

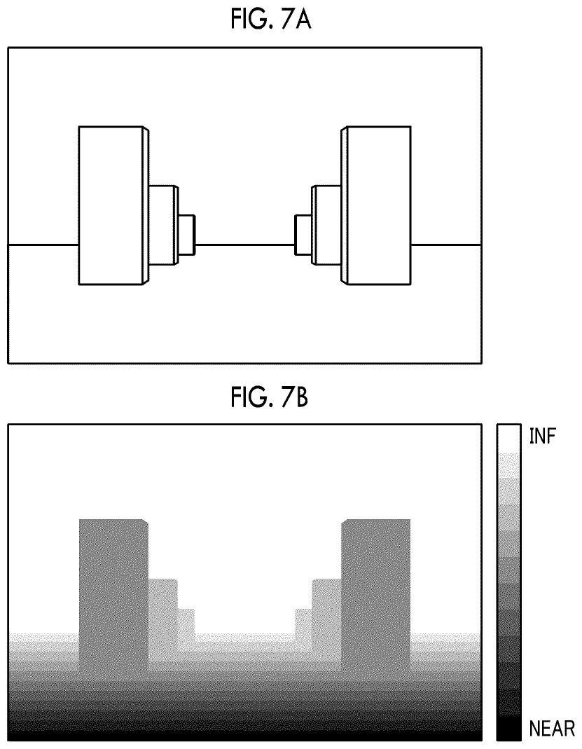

FIGS. 7A and 7B are diagrams showing an example of visualization of the distance image data.

FIG. 7A shows a captured image. FIG. 7B shows an example of visualization of the distance image data. FIG. 7B shows an example of a case where the distance image data is displayed and visualized with a density corresponding to the distance. In this case, the distance value (pixel value) of each pixel is converted into a shade value, and a distance image (distance map) is generated.

As described above, according to the present embodiment, the image quality degradation (image quality degradation caused by the optical system) that has occurred in the image data for distance measurement is corrected before the image data for distance measurement is input to the distance image data generative AI. Accordingly, even in a case where the lens is replaced, the distance image data having high accuracy can be stably generated. That is, even in a case where a lens different from the lens used during the learning is used, the distance image data having high accuracy can be stably generated. In addition, the generation (model learning) of the distance image data generative AI can also be easily performed. That is, since it is not necessary to prepare image data captured by all lenses existing in the world as the image data for learning or to perform learning using a large amount of image data, the generation of the distance image data generative AI can be easily performed. Further, it is also possible to cope with a case where a lens sold after the learning is used, and the distance can be accurately measured.

### Modification Examples

As described above, the image quality degradation caused by the optical system also changes depending on the focal length (zoom position), the F number (F number), and the like. Therefore, in the pre-processing, it is preferable to perform the correction of each item in consideration of the information (information such as the focal length and the F number). That is, it is preferable to acquire information such as the focal length and the F number during the imaging and to perform the correction with the corresponding correction amount. For example, in a case of performing the distortion correction, information on the focal length and the F number during the imaging is acquired, and the distortion correction is performed with the correction amount corresponding to the focal length and the F number during the imaging. Accordingly, more accurate correction can be performed.

### Second Embodiment

As described above, the distance image data can be generated from the image data obtained by the imaging by using the distance image data generative AI. The distance image data can be generated not only from the image data captured for the distance measurement but also from the image data captured for display and recording. Therefore, for example, the distance image data can be generated from the image data captured for the live view or the distance image data can be generated from the image data captured for recording.

In a case where the distance image data is generated from the image data captured for display or recording by using the distance image data generative AI, it is preferable that the image quality degradation caused by the optical system is also corrected for the image data for display or recording and the corrected image data is output to the display destination or the recording destination.

On the other hand, some users regard the distortion, the shading, and the like as the characteristics of the lens (so-called taste of the lens) and do not want to correct the distortion, the shading, and the like. For example, some users regard the brightness shading as the characteristics of the lens and utilize the brightness shading for creating a work.

In the present embodiment, in a case where the distance image data is generated from the image data captured for display or recording by using the distance image data generative AI, different corrections can be performed between the image data for display or recording and the image data for distance measurement.

In the following embodiment, a case where the distance image data is generated from the image data captured for the live view in parallel with the output of the live view will be described as an example.

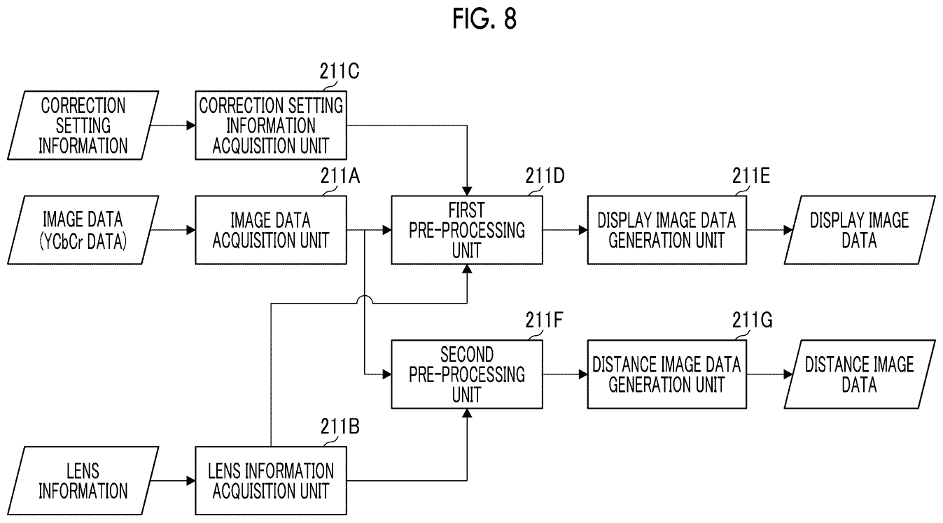

FIG. 8 is a block diagram of main functions of the digital camera regarding the live view output and the distance measurement.

As shown in FIG. 8, the digital camera 1 has functions of an image data acquisition unit 211A, a lens information acquisition unit 211B, a correction setting information acquisition unit 211C, a first pre-processing unit 211D, a display image data generation unit 211E, a second pre-processing unit 211F, a distance image data generation unit 211G, and the like regarding the live view output and the distance measurement. The functions of the units are implemented by the processor 210 of the camera body 100. The processor 210 implements the functions of the units by executing a predetermined program (image data processing program).

### Image Data Acquisition Unit

The image data acquisition unit 211A acquires the image data to be processed. In the present embodiment, the image data to be processed is the image data captured for the live view. The image data for the live view is captured at a predetermined frame rate. The image data acquisition unit 211A acquires the image data captured for the live view in time series. In the present embodiment, the image data (YCbCr data) that is captured for the live view and that is subjected to the development treatment is acquired. The acquired image data (YCbCr data) is added to the first pre-processing unit 211D and the second pre-processing unit 211F.

The image data added to the first pre-processing unit 211D is used for the live view, and the image data added to the second pre-processing unit 211F is used for the distance measurement. Hereinafter, the image data used for the live view will be referred to as the image data for the live view, and the image data used for the distance measurement will be referred to as the image data for the distance measurement, as necessary, to distinguish between the two.

### Lens Information Acquisition Unit

The lens information acquisition unit 211B acquires the lens information of the interchangeable lens 10 mounted on the camera body 100. The acquired lens information is added to the first pre-processing unit 211D and the second pre-processing unit 211F.

### Correction Setting Information Acquisition Unit

The correction setting information acquisition unit 211C acquires the setting information (correction setting information) for the correction performed on the image data for the live view.

In the present embodiment, the correction performed on the image data for recording is also reflected in the image data for the live view. Therefore, the correction setting information acquisition unit 211C acquires the setting information for the correction performed on the image data for recording as the setting information for the correction performed on the image data for the live view.

In the present embodiment, the setting of the correction is the setting of ON or OFF of the correction. The setting of the correction is performed, for example, on a predetermined setting screen. The user uses the camera operation unit 170 to call the setting screen of the correction on the rear surface monitor 150 or the EVF 160 and to set ON or OFF of the correction. In a case where the correction is set to ON, the correction is enabled. In a case where the correction is set to OFF, the correction is disabled. The information of the set ON or OFF of the correction is held in, for example, the memory 220. The correction setting information acquisition unit 211C reads out and acquires the correction setting information from the memory 220. The acquired correction setting information is added to the first pre-processing unit 211D.

### First Pre-Processing Unit

As described above, the image data for live view is added to the first pre-processing unit 211D.

The first pre-processing unit 211D performs predetermined image processing on the image data for live view to correct the image quality degradation caused by the optical system. Similarly to the pre-processing unit 210C of the first embodiment, the first pre-processing unit 211D corrects the image data for live view by using the lens characteristic correction data included in the lens information acquired by the lens information acquisition unit 211B.

In addition, the first pre-processing unit 211D corrects the image data for live view based on the correction setting information added from the correction setting information acquisition unit 211C. That is, the image data for live view is corrected only in a case where the correction is set to ON. In a case where the correction is set to OFF, the image data for live view is output without performing the correction processing.

### Display Image Data Generation Unit

The display image data generation unit 211E generates the image data for display (display image data) from the image data for live view output from the first pre-processing unit 211D. That is, the image data is converted into a format conforming to the output format of the display destination to generate the display image data. The generated display image data is output to the display destination (rear surface monitor 150 and/or EVF 160) and is displayed as the live view. In the present embodiment, the display image data is an example of third image data.

### Second Pre-Processing Unit

As described above, the image data for distance measurement is added to the second pre-processing unit 211F.

The second pre-processing unit 211F performs predetermined image processing on the image data for distance measurement to correct the image quality degradation caused by the optical system. Similarly to the first pre-processing unit 211D, the second pre-processing unit 211F corrects the image data for distance measurement by using the lens characteristic correction data included in the lens information acquired by the lens information acquisition unit 211B. In the first pre-processing unit 211D, the user can turn the correction ON/OFF, but in the second pre-processing unit 211F, the correction is always performed. The image data for distance measurement, in which the image quality degradation caused by the optical system is corrected, is added to the distance image data generation unit 211G.

### Distance Image Data Generation Unit

The distance image data generation unit 211G performs image analysis on the image data for distance measurement after the pre-processing to perform distance measurement and generate distance image data. Similarly to the distance image data generation unit 210D of the first embodiment, the distance image data generation unit 211G generates the distance image data from the image data for distance measurement after the pre-processing by using the distance image data generative AI. The generated distance image data is used for a purpose.

The distance image data can be used not only for distance measurement but also for various types of image processing. For example, the so-called blurriness of the image can be controlled or the luminance can be controlled by referring to the distance image data. For example, by referring to the distance image data, it is possible to blur the image only in the distant region and make the foreground region stand out by image processing. In addition, by referring to the distance image data, it is possible to make the distant region dark and make the foreground region bright by image processing.

### Action

Here, a case where the distance measurement (generation of the distance image data) is performed from the image data captured for the live view simultaneously with the output of the live view will be described as an example.

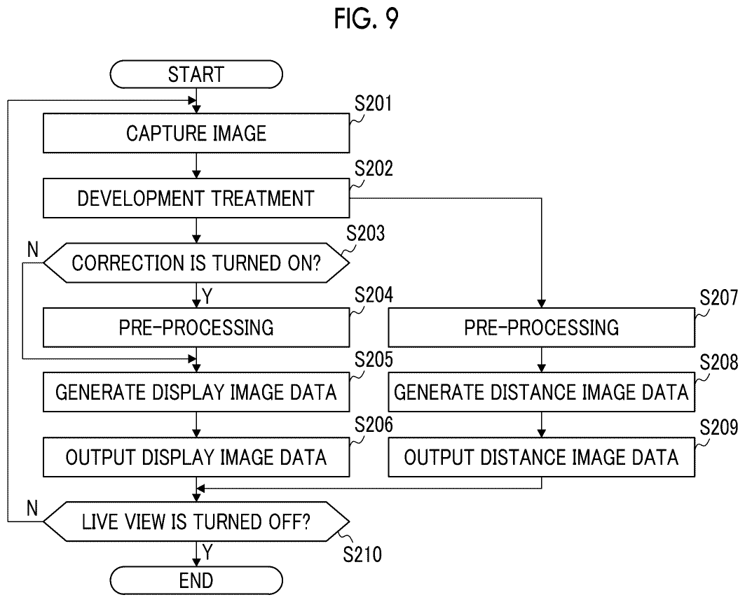

FIG. 9 is a flowchart showing a procedure of processing of the live view output and the distance measurement.

First, an image for the live view is captured (step S201). The image data (RAW data) obtained by the imaging is subjected to development treatment (step S202) and is added to the first pre-processing unit 211D and the second pre-processing unit 211F.

Here, the image data (YCrCb data) after the development treatment is added to the first pre-processing unit 211D as the image data for the live view. On the other hand, the image data after the development treatment is added to the second pre-processing unit 211F as the image data for the distance measurement. Hereinafter, the processing of the output of the live view and the processing of the distance measurement will be described separately.

### (1) Output of Live View

First, it is determined whether or not the correction is turned ON (step S203).

In a case where the correction is ON, the image data for the live view is subjected to the pre-processing in the first pre-processing unit 211D (step S204). That is, the image quality degradation caused by the optical system is corrected by the image processing. The image data for the live view, which has been subjected to the pre-processing, is added to the display image data generation unit 211E.

On the other hand, in a case where the correction is OFF, the image data for the live view is added to the display image data generation unit 211E without being subjected to the pre-processing in the first pre-processing unit 211D.

The display image data generation unit 211E converts the image data for the live view into the image data in the format in accordance with the output format of the display destination. Accordingly, the image data (display image data) of the image (display image) to be displayed as the live view is generated (step S205).

The generated display image data is output to the display destination (rear surface monitor 150 and/or EVF 160) (step S206) and is displayed as the live view.

Thereafter, it is determined whether or not the live view is turned OFF (step S210). In a case where the live view is turned OFF, the processing is ended. On the other hand, in a case where the live view is not turned OFF, the imaging of the image to be displayed next is performed (step S201).

The imaging of the live view is performed at a predetermined frame rate. Therefore, the processing from step S201 to step S206 is repeatedly performed until the live view is turned OFF.

### (2) Distance Measurement (Generation of Distance Image Data)

Next, in the second pre-processing unit 211F, the pre-processing is performed on the image data for distance measurement (step S207).

Next, the distance image data is generated from the image data for distance measurement after the pre-processing using the distance image data generative AI (step S208). Since the image data input to the distance image data generative AI is corrected for the image quality degradation caused by the optical system by the pre-processing, the distance image data having high accuracy can be acquired without being affected by the optical system.

The generated distance image data is output to an output destination according to the purpose (step S209).

The distance measurement is performed in synchronization with the imaging of the image for the live view. Therefore, in a case where the live view is turned off, the distance measurement is also ended.

As described above, according to the present embodiment, in a case where the distance image data is generated from the image data captured for the live view, the correction can be optionally turned on/off for the image data for the live view. Accordingly, the image in accordance with the intention of the user can be checked as the live view. On the other hand, the image data on which the correction processing is always performed is input to the distance image data generative AI. Accordingly, the high-accuracy distance measurement can be performed.

### Modification Examples

### Correction Processing for Image Data for Recording

It is preferable to perform the processing in the same manner as in the case of the live view even in a case where the distance image data is generated from the image data captured for recording. That is, it is preferable to adopt a configuration in which the pre-processing is performed separately from the image data for distance measurement and a configuration in which the correction can be optionally enabled or disabled.

The image data captured for recording is subjected to the pre-processing by the first pre-processing unit 211D, is converted into a predetermined recording format, and is recorded in the recording destination (storage unit 130). The distance image data generated from the image data captured for recording is recorded in the recording destination in association with the image data for recording.

### Correction for Image Data for Display or Recording

In the above-described embodiment, only the ON/OFF setting of the correction is possible for the image data for display and the image data for recording, but a configuration may be adopted in which the intensity of the correction can be changed instead of or in addition to the ON/OFF switching.

In addition, in a case where the content of the correction is wide, a configuration may be adopted in which the correction can be individually turned ON/OFF or the intensity of the correction can be individually set. For example, in a case where the correction of the image quality degradation caused by the optical system is performed, such as the correction of the brightness shading, the correction of the color shading, the correction of the distortion, and the correction of the aberration, the ON/OFF can be individually set for each item, and the intensity can be individually set. As an example, as the correction of the distortion (distortion aberration correction), a configuration is adopted in which the correction of the barrel distortion and the correction of the pincushion distortion can be performed in three stages of strong, medium, and weak in addition to the ON/OFF setting. In addition, for example, as the correction of the color shading, a configuration is adopted in which the difference in color between the center portion and the edge part (shading) can be individually corrected at each of the four corners of the image. In addition, as the correction of the brightness shading (peripheral light amount correction), a configuration is adopted in which the peripheral light amount can be corrected with a correction amount of a total of 11 stages (−5, −4, −3, −2, −1, 0, +1, +2, +3, +4, and +5) (0 is OFF).

Further, a configuration may be adopted in which the display and the recording are separated, and the correction can be individually set.

In addition, in the above-described embodiment, a configuration is adopted in which the user can set the ON/OFF of the correction, but a configuration may be adopted in which the correction is always performed. In addition, a configuration may be adopted in which the correction is automatically turned ON/OFF according to the condition.

### Pre-processing

In the above-described embodiment, a configuration is adopted in which only the image quality degradation caused by the optical system is corrected as the pre-processing, but other correction or image processing can also be performed. For example, a configuration may be adopted in which the luminance, the chroma saturation, and the like can be corrected for the image data for display and/or recording.

In addition, for example, a configuration may be adopted in which the luminance of the image is corrected as the pre-processing for the image data for distance measurement, and the image data having a luminance that is always equal to or higher than a certain level or within a certain range is input to the distance image data generative AI. For the adjustment of the luminance, for example, a photometric result obtained by AE can be used.

### Third Embodiment

In a case where the distance image data is generated by using the distance image data generative AI, a deviation (a deviation in a corresponding positional relationship in the image) may occur between the input image (image data for distance measurement) and the output image (distance image data). In a case where the deviation occurs, for example, in a case of superimposition display, the two images cannot be correctly superimposed, and the visibility is reduced.

The deviation occurs, for example, due to different correction between the image data for display or recording and the image data for distance measurement. For example, in a case where the distortion correction is performed with different correction amounts, the deviation may occur in an edge part of the image (since the magnification/reduction process is performed locally depending on the image height, the deviation may mainly occur in the edge part of the image). In addition, the deviation may occur due to the distance image data generative AI. The deviation is an example of a difference occurring between the image data for display or recording and the distance image data.

In the present embodiment, in a case where the distance image data is generated from the image data captured for display or recording by using the distance image data generative AI, the post-processing is performed on the distance image data generated by the distance image data generative AI to reduce the deviation occurring between the distance image data and the image data for display or recording.

In the following embodiment, a case where the distance image data is generated from the image data captured for live view and the distance image is superimposed on the image of the live view to be displayed will be described as an example.

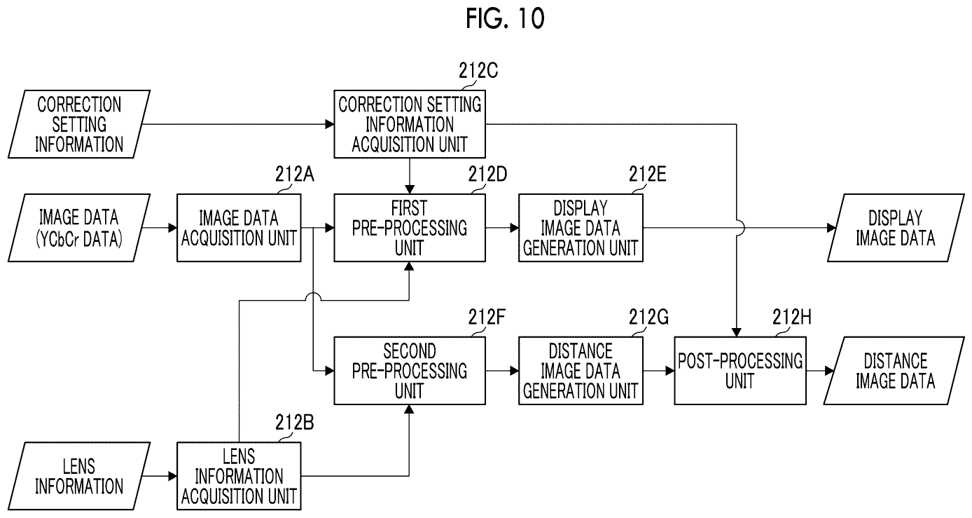

FIG. 10 is a block diagram of main functions of the digital camera regarding the live view output and the distance measurement.

As shown in FIG. 10, the digital camera 1 has functions of an image data acquisition unit 212A, a lens information acquisition unit 212B, a correction setting information acquisition unit 212C, a first pre-processing unit 212D, a display image data generation unit 212E, a second pre-processing unit 212F, a distance image data generation unit 212G, a post-processing unit 212H, and the like regarding the live view output and the distance measurement. The functions of the units are implemented by the processor 210 of the camera body 100. The processor 210 implements the functions of the units by executing a predetermined program (image data processing program).

### Image Data Acquisition Unit

The image data acquisition unit 212A acquires the image data to be processed. In the present embodiment, the image data to be processed is the image data captured for the live view. The image data acquisition unit 212A acquires the image data (YCbCr data) that is captured for live view and that is subjected to the development treatment. The acquired image data (YCbCr data) is added to the first pre-processing unit 212D and the second pre-processing unit 212F.

The image data added to the first pre-processing unit 212D is used for the live view, and the image data added to the second pre-processing unit 212F is used for the distance measurement. Hereinafter, the image data used for the live view will be referred to as the image data for the live view, and the image data used for the distance measurement will be referred to as the image data for the distance measurement, as necessary, to distinguish between the two.

In the present embodiment, the image data (YCrCb data) acquired by the image data acquisition unit 212A is an example of first image data.

### Lens Information Acquisition Unit

The lens information acquisition unit 212B acquires the lens information of the interchangeable lens 10 mounted on the camera body 100. The acquired lens information is added to the first pre-processing unit 212D and the second pre-processing unit 212F.

### Correction Setting Information Acquisition Unit

The correction setting information acquisition unit 212C acquires the setting information for the correction performed on the image data for the live view.

In the present embodiment, the correction performed on the image data for recording is also reflected in the image data for the live view. Therefore, the correction setting information acquisition unit 211C acquires the setting information for the correction performed on the image data for recording as the setting information for the correction performed on the image data for the live view.

For example, in the present embodiment, the brightness shading, the color shading, the distortion, and the aberration can be corrected. Each correction can be individually set to ON/OFF and the intensity can be set. The setting of the correction is performed, for example, on a predetermined setting screen. The setting information for each correction is held in, for example, the memory 220. The correction setting information acquisition unit 212C reads out and acquires the setting information for each correction from the memory 220. The acquired setting information for each correction is added to the first pre-processing unit 212D and the post-processing unit 212H.

### First Pre-processing Unit

The first pre-processing unit 212D performs image processing on the image data for the live view based on the setting information for the correction. In the present embodiment, the brightness shading, the color shading, the distortion, and the aberration can be corrected. The first pre-processing unit 212D corrects the brightness shading, the color shading, the distortion, and the aberration of the image data for the live view based on the setting information for each correction. The correction is performed by using the lens characteristic correction data.

### Display Image Data Generation Unit

The display image data generation unit 212E generates the image data for display (display image data) from the image data for the live view output from the first pre-processing unit 212D. The generated display image data is output to the display destination (rear surface monitor 150 and/or EVF 160) and is displayed as the live view. In the present embodiment, the display image data is an example of fourth image data.

### Second Pre-Processing Unit

The second pre-processing unit 212F performs predetermined image processing on the image data for distance measurement to correct the image quality degradation caused by the optical system. The image data for distance measurement, in which the image quality degradation caused by the optical system is corrected, is added to the distance image data generation unit 212G.

### Distance Image Data Generation Unit

The distance image data generation unit 212G generates the distance image data from the image data for distance measurement after the pre-processing using the distance image data generative AI. The generated distance image data is added to the post-processing unit 212H.

### Post-processing Unit

The post-processing unit 212H performs predetermined image processing on the generated distance image data to reduce the deviation occurring between the distance image data and the display image data. That is, in a case where the distance image is displayed in a superimposed manner on the display image, the image processing is performed on the distance image data such that both the display image and the distance image are displayed without deviation.

The deviation is mainly caused by a difference in correction content in the pre-processing. In particular, the deviation is caused by a difference in the correction amount in a case where the distortion is corrected as the pre-processing. As an example, the post-processing unit 212H performs the image processing on the distance image data based on information on the distortion correction performed on the image data for live view by the first pre-processing unit 212D (information on the correction amount or the like) and information on the distortion correction performed on the image data for distance measurement by the second pre-processing unit 212F (information on the correction amount or the like).

The post-processed distance image data is visualized and output as a distance image to the display destination. The distance image is generated, for example, by expressing the distance value of each pixel in the distance image data in a color or a density. In the present embodiment, the distance image is displayed in a superimposed manner on the image for live view. For example, the distance image is made semi-transparent and displayed in a superimposed manner on the image for live view.

In the present embodiment, the distance image data before the post-processing is an example of first distance image data. In addition, the distance image data after the post-processing is an example of second distance image data.

### Action

Here, a case where all the corrections (corrections for the image data for recording) for the image data for live view are turned OFF will be described as an example. In this case, distortion, edge part light reduction (brightness shading), and the like based on the characteristics of the interchangeable lens 10 appear in the image displayed as the live view.

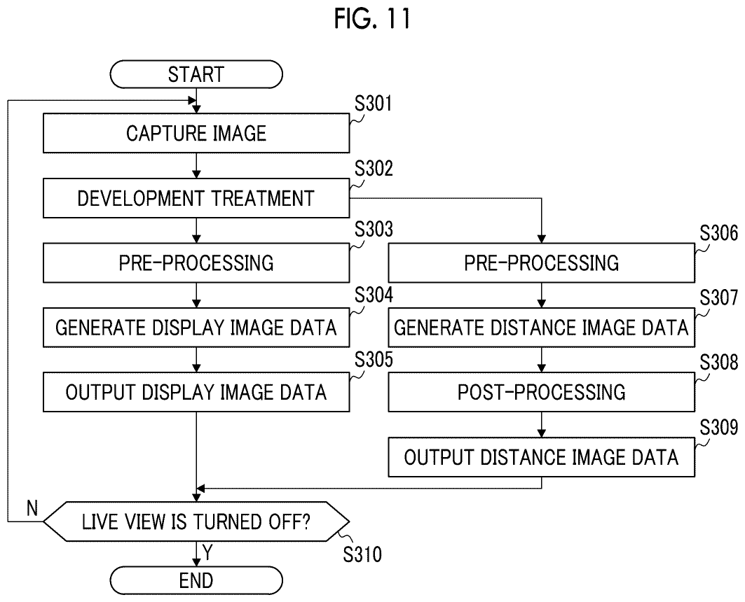

FIG. 11 is a flowchart showing a processing procedure of the output of the live view.

First, the image for live view is captured (step S301). The image data (RAW data) obtained by the imaging is subjected to development treatment (step S302) and is added to the first pre-processing unit 212D and the second pre-processing unit 212F. The image data (YCrCb data) after the development treatment is added to the first pre-processing unit 212D as the image data for live view. On the other hand, the image data after the development treatment is added to the second pre-processing unit 212F as the image data for distance measurement.

The image data for live view added to the first pre-processing unit 212D is subjected to the pre-processing in accordance with the setting of the correction by the user (step S303). As described above, in the present example, since all the corrections are turned OFF, the pre-processing is not performed in the first pre-processing unit 212D, and the image data is added to the display image data generation unit 212E as it is.

The display image data generation unit 212E converts the image data for live view into the image data in a format in accordance with the output format of the display destination. Accordingly, the image data (display image data) of the image (display image) to be output as the live view is generated (step S304).

The generated display image data is output to the display destination (rear surface monitor 150 and/or EVF 160) (step S305) and is displayed as the live view. As described above, the distortion or the like based on the characteristics of the interchangeable lens 10 appears in the displayed image.

On the other hand, the image data for distance measurement added to the second pre-processing unit 212F is subjected to the predetermined pre-processing in the second pre-processing unit 212F, and the image quality degradation caused by the optical system is corrected (step S306).

The image data for distance measurement subjected to the pre-processing is added to the distance image data generation unit 212G. The distance image data generation unit 212G generates the distance image data from the image data for distance measurement by using the distance image data generative AI (step S307).

The generated distance image data is added to the post-processing unit 212H, and the post-processing is performed (step S308). The post-processing unit 212H corrects the distance image data such that the deviation occurring between the distance image data and the display image data is reduced. Specifically, the image processing is performed on the distance image data based on the information on the distortion correction performed on the image data for live view and the information on the distortion correction performed on the image data for distance measurement, and the deviation (deviation based on the distortion) occurring between the distance image data and the display image data is reduced. In the present example, since the correction for the image data for live view is turned off, the image processing is performed on the distance image data based on the information on the distortion correction performed on the image data for distance measurement.

The post-processed distance image data is visualized and output as the distance image to the display destination (step S309). In the present embodiment, the distance image is displayed in a superimposed manner on the image of the live view.

Thereafter, it is determined whether or not the live view is turned off (step S310). In a case where the live view is turned OFF, the processing is ended. On the other hand, in a case where the live view is not turned off, the imaging of the next image to be displayed is performed (step S301).

The imaging of the live view is performed at a predetermined frame rate. Therefore, the processing from step S301 to step S309 is repeatedly performed until the live view is turned off.

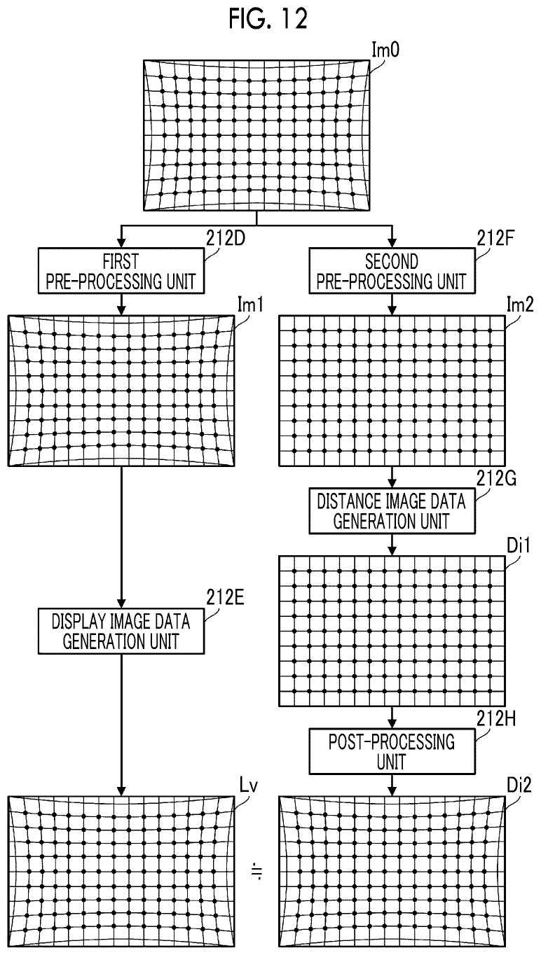

FIG. 12 is a diagram showing a flow of processing until the image of the live view and the distance image are generated.

FIG. 12 shows an example of a case where distortion (for example, barrel distortion) occurs in the captured image, and shows an example of a case where the live view is output without correcting the distortion.

The image data Im0 obtained by the imaging is subjected to the development treatment and is added to the first pre-processing unit 212D and the second pre-processing unit 212F.

The image data (image data for the live view) added to the first pre-processing unit 212D is subjected to the pre-processing according to the setting and is added to the display image data generation unit 212E. As described above, in the present example, the live view is output without correcting the distortion. Therefore, in the present example, the image data Im1 in a state where the distortion occurs is added to the display image data generation unit 212E.

The display image data generation unit 212E generates the display image data Lv from the image data Im1 in a state where the distortion occurs and outputs the display image data Lv to the display destination. Therefore, the display image data Lv is composed of the image data in which the distortion occurs.

On the other hand, the image data (image data for the distance measurement) added to the second pre-processing unit 212F is subjected to the predetermined pre-processing, and the image quality degradation caused by the optical system is corrected. Therefore, the image data Im2 after the pre-processing is composed of the image data in which the distortion is corrected.

The image data Im2 in which the image quality degradation caused by the optical system is corrected by the pre-processing is added to the distance image data generation unit 212G. The distance image data generation unit 212G generates the distance image data Di1 based on the image data Im2 in which the image quality degradation caused by the optical system is corrected (the distance image data Di1 is generated by using the distance image data generative AI). Therefore, the generated distance image data Di1 is also composed of the distance image data without the distortion. In a case where the distance image data Di1 is displayed to be superimposed on the display image data Lv in which the distortion is not corrected, a deviation occurs between the two. Therefore, the distance image data Di1 generated by the distance image data generation unit 212G is added to the post-processing unit 212H, and the post-processing is performed.

The post-processing unit 212H performs the post-processing on the distance image data Di1 such that the deviation occurring between the distance image data Di1 and the display image data Lv is reduced. In the present example, the distortion appears in the display image data Lv. Therefore, the image processing is performed on the distance image data Di1 such that the same distortion as the display image data Lv appears (the image processing is performed such that the same type of the distortion as the display image data Lv appears).

The deviation occurring between the post-processed distance image data Di2 and the display image data Lv is reduced. Accordingly, in a case where the distance image is displayed to be superimposed on the image (display image) displayed as the live view, the two can be displayed without the deviation.

As described above, according to the present embodiment, the deviation occurring between the distance image data and the image data for display or recording can be reduced by performing the post-processing on the distance image data. Accordingly, for example, in a case where the distance image is displayed to be superimposed on the captured image, the visibility can be improved. In addition, the distance of each subject in the image can be accurately associated.

### Modification Examples

### Post-Processing Unit

In the above-described embodiment, the distance image data is corrected such that the deviation based on the correction of the distortion is reduced, but the deviation (difference) occurring between the distance image data output from the distance image data generative AI and the image data for display or recording may also occur due to other factors. Therefore, it is preferable that the post-processing unit 212H is configured to also eliminate the deviation caused by the other factors.

For example, in a case where the deviation occurs due to the distance image data generative AI, data necessary for the correction is collected in advance, the correction information is generated based on the collected data, and the distance image data is corrected using the generated correction information.

### Processing on Image Data for Recording

It is preferable to perform the processing in the same manner as in the case of the live view even in a case where the distance image data is generated from the image data captured for recording. For example, in a case where the distance image data is generated from the image data captured for recording and the generated distance image data is recorded in association with the image data for recording, the post-processing is performed on the distance image data to reduce the deviation occurring between the distance image data and the image data for recording. Accordingly, for example, in a case where the recorded image is reproduced and displayed by superimposing the distance image, the occurrence of the deviation can be reduced, and the visibility can be improved.

### Fourth Embodiment

In the third embodiment, the deviation occurring between the image data for display or recording and the distance image data is reduced by performing the post-processing on the distance image data.

In the present embodiment, the deviation occurring between the image data for display or recording and the distance image data is reduced by performing the post-processing on the image data for display or recording.

Hereinafter, a case where the distance image data is generated from the image data captured for the live view and the distance image is superimposed on the image of the live view to be displayed will be described as an example.

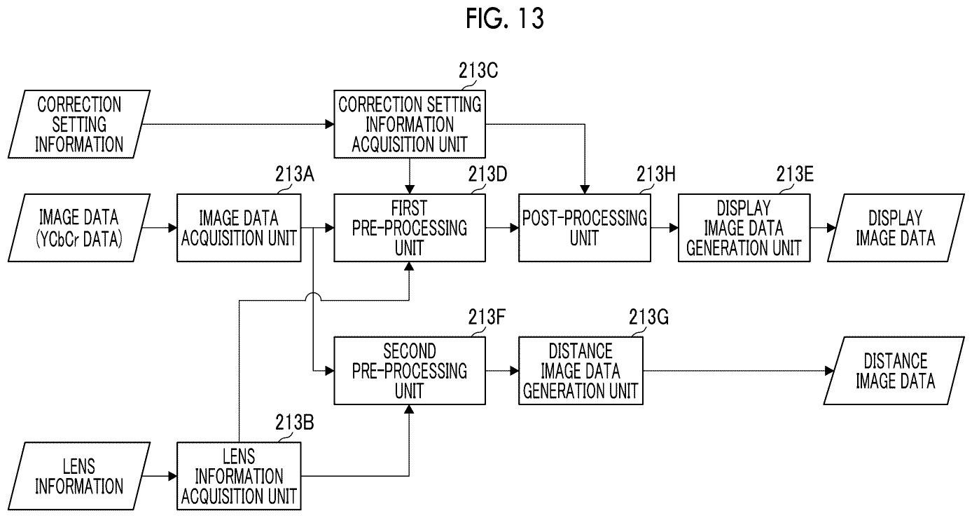

FIG. 13 is a block diagram of main functions of the digital camera regarding the live view output and the distance measurement.

As shown in FIG. 13, the digital camera 1 has functions of an image data acquisition unit 213A, a lens information acquisition unit 213B, a correction setting information acquisition unit 213C, a first pre-processing unit 213D, a display image data generation unit 213E, a second pre-processing unit 213F, a distance image data generation unit 213G, a post-processing unit 213H, and the like regarding the live view output and the distance measurement. The functions of the units are implemented by the processor 210 of the camera body 100. The processor 210 implements the functions of the units by executing a predetermined program (image data processing program).

The functions of the units other than the post-processing unit 213H, that is, the functions of the image data acquisition unit 213A, the lens information acquisition unit 213B, the correction setting information acquisition unit 213C, the first pre-processing unit 213D, the display image data generation unit 213E, the second pre-processing unit 213F, and the distance image data generation unit 213G are substantially the same as the functions of the image data acquisition unit 212A, the lens information acquisition unit 212B, the correction setting information acquisition unit 212C, the first pre-processing unit 212D, the display image data generation unit 212E, the second pre-processing unit 212F, and the distance image data generation unit 212G in the digital camera 1 according to the third embodiment. Therefore, here, only the function of the post-processing unit 213H will be described.

### Post-Processing Unit

The post-processing unit 213H performs image processing on the image data for the live view to reduce a deviation that occurs between the image data for the live view and the distance image data. As an example, in the present embodiment, the image processing is performed on the image data for the live view such that the distortion is substantially the same as the distortion of the image data input to the distance image data generative AI.

As described above, in a case where the correction amounts (intensities) of the distortion correction in the first pre-processing unit 213D and the distortion correction in the second pre-processing unit 213F are different from each other, a deviation may occur between the image (display image) displayed as the live view and the distance image. In the present embodiment, the image processing is performed on the image data for the live view such that the distortion is substantially the same as the distortion of the image data input to the distance image data generative AI, and the deviation that occurs between the image data for the live view and the distance image data is reduced.

The post-processing unit 213H performs the image processing on the image data for the live view based on the information on the correction performed by the first pre-processing unit 213D and the information on the correction performed on the image data for the distance measurement by the second pre-processing unit 213F.

In the present embodiment, the image data before the post-processing by the post-processing unit 213H is an example of fifth image data, and the image data after the post-processing is an example of sixth image data.

### Action

Here, a case where the correction (correction of the image quality degradation caused by the optical system) for the image data for recording is turned OFF will be described as an example. The setting of the correction for the image data for recording is also applied to the live view.

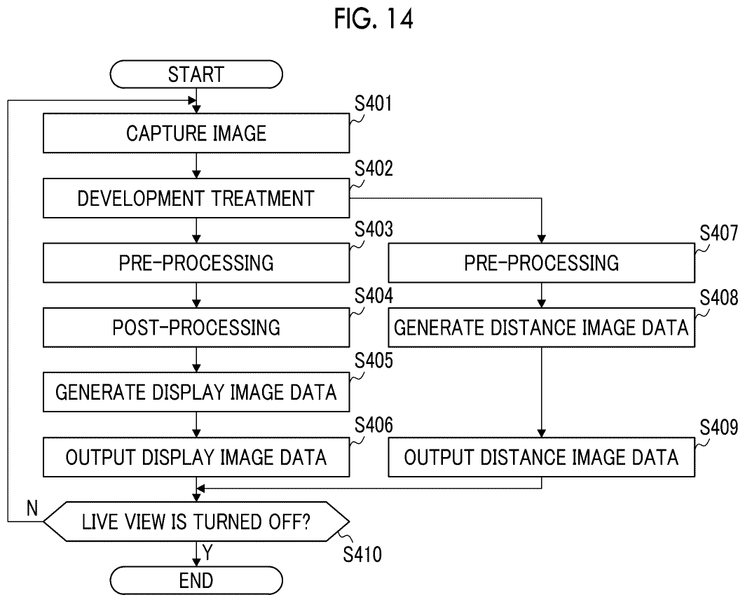

FIG. 14 is a flowchart showing a processing procedure of the output of the live view.

First, the image for the live view is captured (step S401). The image data (RAW data) obtained by the imaging is subjected to the development treatment (step S402) and is added to the first pre-processing unit 213D and the second pre-processing unit 213F. The image data (YCrCb data) after the development treatment is added to the first pre-processing unit 213D as the image data for the live view. On the other hand, the image data after the development treatment is added to the second pre-processing unit 213F as the image data for the distance measurement.

The image data for the live view added to the first pre-processing unit 213D is subjected to the pre-processing in accordance with the setting of the correction by the user (step S403). As described above, in the present example, since all the corrections are turned OFF, the pre-processing is not performed in the first pre-processing unit 213D, and the image data is added to the post-processing unit 213H as it is.

The image data for the live view added to the post-processing unit 213H is subjected to predetermined image processing as the post-processing (step S404). In the present embodiment, the image processing is performed such that the distortion is substantially the same as the image data input to the distance image data generative AI. Accordingly, the deviation between the image data for the live view and the distance image data is reduced. The image data for the live view subjected to the post-processing is added to the display image data generation unit 213E.

The display image data generation unit 213E converts the image data for the live view into the image data in a format in accordance with the output format of the display destination. Accordingly, the image data (display image data) of the image (display image) to be displayed as the live view is generated (step S405). The generated display image data is output to the display destination (rear surface monitor 150 and/or EVF 160) (step S406) and is displayed as the live view.

On the other hand, the image data for the distance measurement added to the second pre-processing unit 213F is subjected to the predetermined pre-processing in the second pre-processing unit 213F, and the image quality degradation caused by the optical system is corrected (step S407).

The image data for the distance measurement subjected to the pre-processing is added to the distance image data generation unit 213G. The distance image data generation unit 213G generates the distance image data from the image data for the distance measurement by using the distance image data generative AI (step S408).

The generated distance image data is visualized and is output to the display destination as the distance image (step S409). In the present embodiment, the distance image is displayed in a superimposed manner on the image of the live view.

Thereafter, it is determined whether or not the live view is turned off (step S410). In a case where the live view is turned OFF, the processing is ended. On the other hand, in a case where the live view is not turned off, the imaging of the image to be displayed next is performed (step S401).

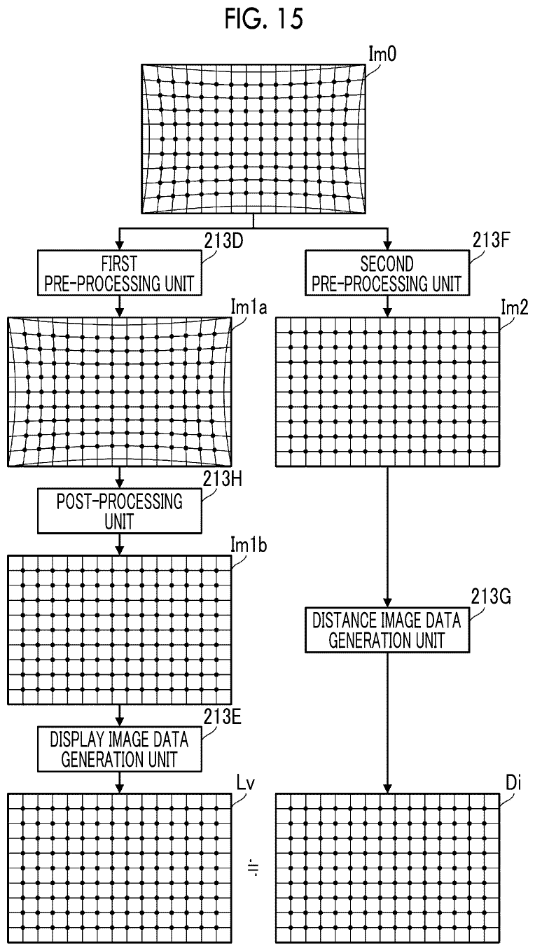

FIG. 15 is a diagram showing a flow of processing until the image of the live view and the distance image are generated.

FIG. 15 shows an example of a case where distortion (barrel distortion as an example) occurs in the captured image, and shows an example of a case where the setting of the correction (correction of the image quality degradation caused by the optical system) for the image data for recording is turned off.

The image data Im0 obtained by the imaging is subjected to the development treatment and is added to the first pre-processing unit 213D and the second pre-processing unit 213F.

The image data (image data for distance measurement) added to the second pre-processing unit 213F is subjected to predetermined pre-processing, and the image quality degradation caused by the optical system is corrected. Therefore, the image data Im2 after the pre-processing is composed of the image data in which the distortion is corrected.

The image data Im2 in which the image quality degradation caused by the optical system is corrected by the pre-processing is added to the distance image data generation unit 213G. The distance image data generation unit 213G generates the distance image data Di based on the image data Im2 in which the image quality degradation caused by the optical system is corrected (the distance image data Di is generated by using the distance image data generative AI). Therefore, the generated distance image data Di is also composed of the distance image data without the distortion.

On the other hand, the image data (image data for live view) added to the first pre-processing unit 213D is subjected to the pre-processing according to the setting and is added to the post-processing unit 213H. As described above, in the present example, since the correction for the image data for recording is turned OFF, the image data is added to the post-processing unit 213H as it is. Therefore, in the present example, the image data Im1a in a state in which the distortion has occurred is added to the post-processing unit 213H.

The post-processing unit 213H performs the post-processing on the image data Im1a for live view such that the deviation occurring between the image data Im1a and the distance image data Di is reduced. In the present example, the image processing is performed such that the distortion is substantially the same as the distortion of the image data Im2 input to the distance image data generative AI. The post-processing reduces the deviation occurring between the image data Im1b for live view and the distance image data Di.

The image data Im1b for live view, which has been subjected to the post-processing, is added to the display image data generation unit 213E. The display image data generation unit 212E generates the display image data Lv from the image data Im1b for live view after the post-processing and outputs the display image data Lv to the display destination. The display image data Lv is the display image data in which the deviation occurring between the display image data Lv and the distance image data Di is reduced. Therefore, even in a case where the distance image is superimposed and displayed on the image displayed as the live view, the two images can be displayed without the deviation.

As described above, according to the present embodiment, the deviation occurring between the image data for live view and the distance image data can be reduced by performing the post-processing on the image data for live view. Accordingly, for example, in a case where the distance image is superimposed and displayed on the image displayed as the live view, the visibility can be improved. In addition, the distance of each subject in the image can be accurately associated.

### Modification Examples

### Post-processing Unit

In the above-described embodiment, the configuration is adopted in which the image data for display or recording is corrected such that the deviation based on the correction of the distortion is reduced, but the deviation (difference) occurring between the image data for display or recording and the distance image data may also occur due to other factors. Therefore, it is preferable that the post-processing unit 213H is configured to also eliminate the deviation caused by the other factors.

For example, in a case where the deviation occurs due to the distance image data generative AI, the data necessary for the correction is collected in advance, the correction information is generated based on the collected data, and the image data for display or recording is corrected by using the generated correction information.

### Processing on Image Data for Recording

In a case where the distance image data is generated from the image data captured for recording, the deviation occurring between the image data for recording and the distance image data may be reduced by performing the image processing.

In the above-described embodiment, the first pre-processing unit 213D is configured to perform the correction based on the setting of the user, but a configuration in which the first pre-processing unit 213D is omitted can also be adopted. In this case, for example, the post-processing unit 213H performs the correction with the same content as the correction performed by the second pre-processing unit 213F.

In addition, in a case where the recording image data is reproduced, the deviation occurring between the image data for recording and the distance image data may be reduced by performing the image processing.

### Fifth Embodiment

It is preferable that the distance measurement can be performed from the recording image data. Therefore, in the present embodiment, in a case where the imaging for recording is performed, the image data for distance measurement is recorded in association with the image data for recording. The image data for distance measurement to be recorded is the image data subjected to the pre-processing. That is, the image data for distance measurement is the image data in which the image quality degradation caused by the optical system is corrected.

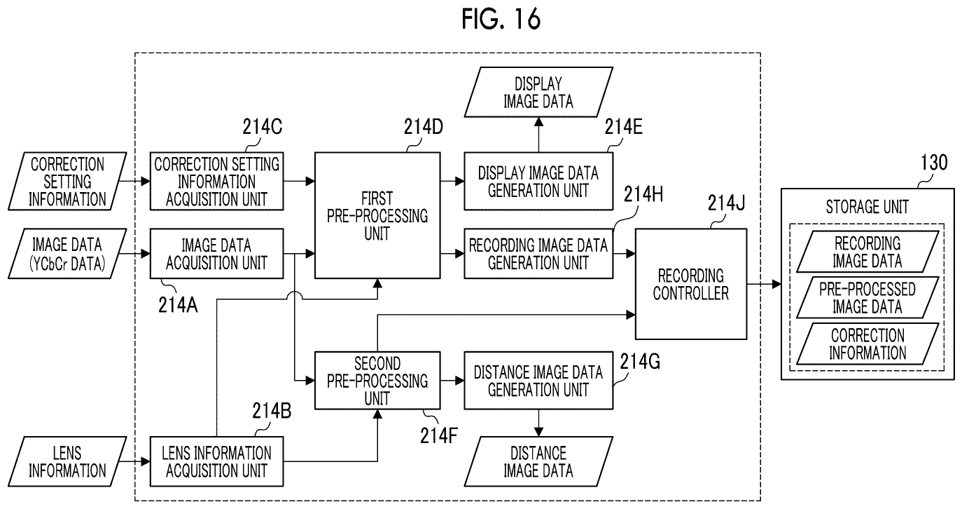

FIG. 16 is a block diagram of main functions of the digital camera regarding the recording of the image data obtained by the imaging.

As shown in FIG. 16, regarding the recording of the image data obtained by the imaging, the digital camera has functions of an image data acquisition unit 214A, a lens information acquisition unit 214B, a correction setting information acquisition unit 214C, a first pre-processing unit 214D, a display image data generation unit 214E, a second pre-processing unit 214F, a distance image data generation unit 214G, a recording image data generation unit 214H, a recording controller 214J, and the like. The functions of the units are implemented by the processor 210 of the camera body 100. The processor 210 implements the functions of the units by executing a predetermined program (image data processing program).

The functions of the units other than the recording image data generation unit 214H and the recording controller 214J, that is, the functions of the image data acquisition unit 214A, the lens information acquisition unit 214B, the correction setting information acquisition unit 214C, the first pre-processing unit 214D, the display image data generation unit 214E, the second pre-processing unit 214F, and the distance image data generation unit 214G are substantially the same as the functions of the image data acquisition unit 211A, the lens information acquisition unit 211B, the correction setting information acquisition unit 211C, the first pre-processing unit 211D, the display image data generation unit 211E, the second pre-processing unit 211F, and the distance image data generation unit 211G in the digital camera 1 according to the second embodiment. Therefore, here, only the functions of the recording image data generation unit 214H and the recording controller 214J will be described.

In the digital camera of the present embodiment, the distance image data is always generated from the image data (including both the image data for display and the image data for recording) obtained by the imaging.

### Recorded Image Data Generation Unit

The recording image data generation unit 214H generates the image data for recording (recording image data) from the image data subjected to the pre-processing by the first pre-processing unit 214D. For example, the image data in a joint photographic experts group (JPEG) format is generated. The generated recording image data is added to the recording controller 214J.

### Recording Controller

The recording controller 214J records the recording image data generated by the recording image data generation unit 214H in the recording destination. In the present embodiment, the recording image data is recorded in the storage unit 130.

In a case of recording the recording image data, the recording controller 214J acquires the corresponding image data for distance measurement and the correction information (information on the parameter used for the correction processing, and the like) used for the pre-processing of the image data for distance measurement, and records the image data for distance measurement and the correction information in the recording destination in association with the recording image data (the correction information is also associated with the image data for distance measurement). The image data for distance measurement to be recorded is the image data (pre-processed image data) subjected to the pre-processing by the second pre-processing unit 214F. That is, the image data is the image data in which the image quality degradation caused by the optical system is corrected.

In the present embodiment, the recording image data is an example of third image data. In addition, the pre-processed image data is an example of second image data. In addition, the correction information is an example of information used for generating the pre-processed image data (second image data).

### Action

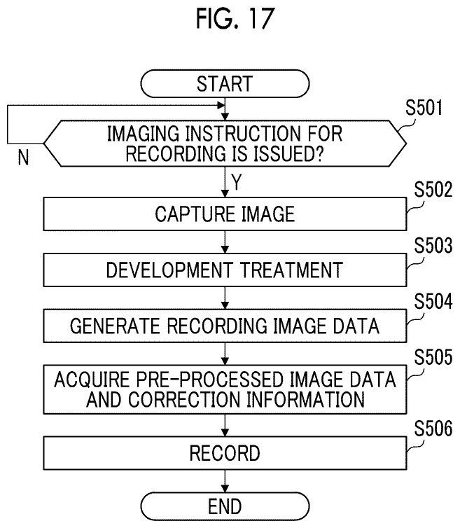

FIG. 17 is a flowchart showing a procedure of processing in a case where the image data is recorded.

It is determined whether or not the imaging instruction for recording is issued (step S501). The image for recording is captured in response to the imaging instruction (step S502). The image data (RAW data) obtained by the imaging is subjected to development treatment (step S503) and is converted into the image data for recording (recording image data) (step S504).

As described above, in the digital camera of the present embodiment, the distance image data is always generated from the image data obtained by the imaging. Therefore, the distance image data is also generated from the image data captured for recording.

Here, the distance image data is generated by inputting the image data (pre-processed image data) generated by performing predetermined pre-processing on the image data captured for recording to the distance image data generative AI. In a case where the recording image data is recorded, the corresponding pre-processed image data and the correction information used to generate the pre-processed image data are acquired (step S505). Then, the recording image data is recorded in the recording destination (storage unit 130) in association with the acquired pre-processed image data and the correction information (step S506).

As described above, according to the present embodiment, the pre-processed image data used to generate the distance image data and the correction information used to generate the pre-processed image data are recorded in the recording destination in association with the recording image data. Accordingly, the distance image data can be generated even after the imaging.

In addition, by recording the pre-processed image data in this way, for example, the pre-processed image data can be used for retraining the distance image data generative AI or can be separately newly used for creating the distance image data generative AI. In addition, for example, the pre-processed image data can also be used for cause analysis in a case where the distance image data generative AI outputs a large erroneous distance.

### Modification Examples

In the above-described embodiment, the pre-processed image data and the correction information are recorded in association with the recording image data, but a configuration may be adopted in which the distance image data is also recorded in association with the recording image data. In addition, a configuration may be adopted in which only the pre-processed image data is recorded in association with the recording image data. In addition, a configuration may be adopted in which the image data before the pre-processing and the correction information are recorded in association with each other instead of the pre-processed image data.

In addition, the form of association is not particularly limited, and any form may be adopted as long as the data associated with each other can be specified. For example, a configuration may be adopted in which information on data associated with a header or the like is recorded and associated with the additional information. In addition, for example, a configuration may be adopted in which a management file is created and the data associated with each other on the management file is managed. In addition, a configuration may be adopted in which the data associated with each other is recorded in one file.

### Other Embodiments

### Preprocessing (1) on Image Data for Distance Measurement

In the embodiment, the configuration is adopted in which the brightness shading correction, the color shading correction, the distortion correction, and the aberration correction are performed as the pre-processing on the image data for distance measurement, but the content of the pre-processing performed on the image data for distance measurement is not limited thereto. In addition, it is not always necessary to perform all of these corrections. It is preferable to correct the image quality degradation that affects the generation of the distance image data among the image quality degradations caused by the optical system.

In addition, in the embodiment, the configuration is adopted in which the information necessary for the correction is acquired from the interchangeable lens 10 and the image data for distance measurement is corrected (preprocessed), but the method of correcting the image data for distance measurement is not limited thereto. For example, a configuration may be adopted in which the predetermined correction item is corrected with a predetermined correction amount (correction parameter). For example, a configuration may be adopted in which the distortion correction is performed with a predetermined correction amount.

In addition, in the configuration in which the information necessary for the correction is acquired from the lens or the like and the image data for distance measurement is corrected (preprocessed) as in the embodiment, a configuration may be adopted in which the execution of the pre-processing is restricted in a case where the information necessary for the correction cannot be acquired. For example, in the embodiment, in a case where the lens information cannot be acquired from the interchangeable lens 10, a configuration can be adopted in which the pre-processing is not performed. In this case, the distance image data is generated without performing the pre-processing. That is, the image data for distance measurement is input to the distance image data generative AI without performing the pre-processing, and the distance image data is generated.

In addition, in a case where the information necessary for the correction cannot be acquired, the generation of the distance image data may be restricted. For example, in the embodiment, in a case where the lens information cannot be acquired from the interchangeable lens 10, a configuration can be adopted in which the distance image data is not generated.

In addition, in a case where the information necessary for the correction cannot be acquired, a configuration may be adopted in which a notification or a warning is provided that the information necessary for the correction cannot be acquired, instead of or in addition to restricting the execution of the pre-processing or the generation of the distance image data. For example, in the embodiment, in a case where the lens information cannot be acquired from the interchangeable lens 10, a notification or a warning is provided to the user that the lens information cannot be acquired. For example, a message indicating that the lens information cannot be acquired is output to the rear surface monitor 150 or the EVF 160 to provide a notification. Similarly, in a case where the pre-processing is stopped, it is preferable to output a message indicating that the pre-processing cannot be performed or a message indicating that the distance image data is generated without performing the pre-processing to the rear surface monitor 150 or the EVF 160. In addition, similarly in a case where the pre-processing is stopped, it is preferable to output a message indicating that the distance image data cannot be generated to the rear surface monitor 150 or the EVF 160.

In addition, in a case where a plurality of items are corrected, in a case where the information necessary for the correction can be acquired for only some of the items, a configuration may be adopted in which the correction is performed only for the items for which the information can be acquired. In this case, it is preferable to output a message indicating that the correction is performed only for some of the items or a message indicating that the correction cannot be performed for some of the items to provide a notification to the user. For example, in the embodiment, in a case where only the distortion correction data can be acquired, only the distortion correction is performed as the pre-processing. Then, a notification is provided that only the distortion correction is performed as the pre-processing.

In addition, a configuration may be adopted in which the pre-processing is performed only in a case where a specific condition is satisfied. For example, in a case where there are a plurality of correction items, a necessary correction item is determined. Then, a configuration is adopted in which the pre-processing is performed only in a case where the information necessary for the correction is obtained for the necessary correction item. In this case, a configuration may be adopted in which the correction is performed only for the necessary correction item. In addition, a configuration may be adopted in which the correction is performed using the obtained information for the necessary item and the item for which the information necessary for the correction is obtained, and the correction is performed under a predetermined condition (for example, a parameter or the like) for the item for which the information necessary for the correction is not obtained. For example, in the embodiment, a configuration is adopted in which the distortion correction is set as the necessary correction item and the pre-processing is performed only in a case where the distortion correction data can be acquired. In this case, a configuration may be adopted in which the correction is performed only for the item for which the information necessary for the correction can be acquired, except for the distortion correction. Alternatively, a configuration may be adopted in which the correction is performed under a predetermined condition (for example, a parameter or the like) for the item for which the information necessary for the correction is not obtained. In the present example, the information necessary for the correction for each correction item is an example of a plurality of pieces of information, and the information necessary for the correction for the necessary correction item is an example of specific information. In addition, the correction information (correction information for the item for which the information necessary for the correction is not obtained) used in a case of performing the correction under the predetermined condition is an example of the second information.

In addition, in a case where a plurality of items are corrected and the information necessary for the correction can be acquired only for some items, a configuration may be adopted in which the execution of the pre-processing (including the stop) is restricted or the generation of the distance image data (including the stop) is restricted. In this case, it is preferable to notify the user that the execution of the pre-processing is restricted and that the generation of the distance image data is restricted.

### Preprocessing (2) for Distance Measurement Image Data

In the embodiment, a configuration is adopted in which the image quality degradation (image quality degradation caused by the optical system) based on the characteristics of the lens is corrected, but a configuration may be adopted in which the image quality degradation based on the characteristics of the image sensor is also corrected in the same manner. In this case, it is preferable that the distance image data generative AI performs machine learning using the image data in which the image quality degradation based on the characteristics of the image sensor is corrected as the image data for learning to generate the image data.

Further, the luminance of the image data for distance measurement may be measured, and the image data may be corrected to have a specified luminance. For example, the gain may be corrected such that the luminance is the specified luminance or the luminance within the specified range. As the luminance of the image data, a photometric result obtained by AE may be used.

### Acquisition of Information Necessary for Correction

In the embodiment, a configuration is adopted in which the lens information including the lens characteristic correction information is acquired from the interchangeable lens to acquire the information necessary for correcting the image quality degradation caused by the optical system, but a method of acquiring the information necessary for correction is not limited thereto. For example, a configuration may be adopted in which the correction information for each interchangeable lens is held on the camera body side (for example, held in the memory 220). In this case, for example, information (for example, identification information such as lens model data) for specifying the interchangeable lens is acquired from the interchangeable lens, and the corresponding correction information is read out from the memory to be acquired. In addition, for example, a configuration may be adopted in which the correction information is held on a network and the correction information of the interchangeable lens mounted on the camera body is acquired through the network.

### Image Data for Distance Measurement

In the embodiment, the YCrCb data is adopted as the image data for distance measurement, but the image data used for distance measurement (image data to be input to the distance image data generative AI and image data to be subjected to the pretreatment) is not limited thereto.

For example, only the brightness data Y in the YCrCb data may be used as the image data for distance measurement. Alternatively, only the color difference data Cb or the color difference data Cr may be used as the image data for distance measurement. In the present example, the YCrCb data is an example of first image data, and the brightness data Y and the color difference data Cb and Cr are examples of mixed image data (data in which the color components of R, G, and B are weighted and mixed).

In addition, for example, in a case where the YCrCb data is used as the image data for distance measurement, the distance image data may be generated from each of the brightness data Y and the color difference data Cr and Cb. In this case, the distance image data generative AI corresponding to each image data is prepared. In addition, in a case where the distance image data is individually generated from each of the brightness data Y and the color difference data Cr and Cb, a configuration may be adopted in which a predetermined integration processing is further performed to generate one distance image data.

In addition, RGB data (image data of color components consisting of R, G, and B) can also be used as the image data for distance measurement. For the RGB data, a configuration may be adopted in which the distance image data is individually generated from each of the color components of R, G, and B. In this case, the distance image data generative AI corresponding to each component is prepared. In addition, in a case where the distance image data is generated from each of the color components of R, G, and B, a configuration may be adopted in which a predetermined integration processing is further performed to generate one distance image data. In the present example, the RGB data is another example of the first image data, and each color component of R, G, and B is an example of the component.

In a case where the distance image data is generated using one component of the RGB data, it is preferable to use a component capable of expressing the highest luminance. For example, it is preferable to adopt a configuration in which the distance image data is generated from the image data of G for the RGB data. In addition, it is preferable to adopt a configuration in which the distance image data is generated from the brightness data Y for the YCrCb data.

In addition, RAW data and image data after the compression processing can also be used as the image data for distance measurement. As described above, the image data for distance measurement is not limited to data that can be directly visualized, and also includes data in a state that can be visualized by performing appropriate processing. Therefore, for example, data having a structure in which signal values or pixel values are continuously arranged in one dimension or two dimensions is also included.

In addition, the image data to be processed is not limited to the image data of the still image, and also includes the image data of the motion picture.

### System Configuration

In the embodiment described above, a case where the present invention is applied to the lens-interchangeable digital camera has been described as an example, but the application of the present invention is not limited thereto. The present invention can also be applied to a lens-integrated digital camera. In this case, correction information corresponding to the focal length, the F number, and the like is held, and the image data for distance measurement is subjected to the pretreatment (processing of correcting the image quality degradation caused by the optical system) according to the focal length, the F number, and the like.

In addition, the application of the present invention is not limited to the digital camera, and can also be applied to an imaging apparatus such as a video camera, a television camera, and a cinema camera. Further, the present invention can also be applied to an imaging apparatus incorporated in another device. For example, the present invention can also be applied to an imaging apparatus incorporated in a smartphone, a personal computer, or the like.

In addition, in a case where the present invention is applied to the imaging apparatus such as the digital camera, a configuration can be adopted in which some functions are implemented by an external apparatus. For example, a configuration may be adopted in which the digital camera and a computer on a network are connected to each other in a communicable manner, and some functions are implemented by the computer on the network. For example, a configuration may be adopted in which a function of generating the distance image data is implemented by the computer on the network.

In addition, in the embodiment described above, a case where the image data captured by the imaging apparatus (digital camera) is processed in the imaging apparatus has been described as an example. However, the present invention can also be applied to a case where the image data captured by the imaging apparatus is processed by an external apparatus. The present invention can also be applied to a case where the image data captured by the imaging apparatus such as the digital camera is taken into an external computer and processed. In this case, the external computer functions as the image data processing device. In addition, in this case, a configuration may be adopted in which the image data captured by the imaging apparatus is taken into the external computer as appropriate and processed, or a configuration may be adopted in which the recording image data is taken into the external computer and processed.

### Others

The processing unit that provides the function of the image data processing device can be configured by various processors. The various processors include, in addition to a graphic processing unit (GPU) which is a general-purpose processor, a programmable logic device (PLD) which is a processor whose circuit configuration can be changed after manufacturing such as a field programmable gate array (FPGA), and a dedicated circuitry which is a processor having a circuit configuration specifically designed to execute specific processing such as an application specific integrated circuit (ASIC). One processing unit may be configured of one of various processors or may be configured of two or more processors of the same type or different types. For example, one processing unit may be configured by a combination of a plurality of FPGAs or a combination of a CPU and an FPGA. Alternatively, a plurality of processing units may be composed of one processor. As an example of configuring a plurality of processing units with one processor, first, there is a form in which, as typified by computers used for a client, a server, or the like, one processor is configured by combining one or more CPUs and software, and the processor functions as a plurality of processing units. Second, as typified by a system on chip (SoC) or the like, a processor that realizes the functions of the entire system including the plurality of processing units by using one integrated circuit (IC) chip is used. Various processing units are composed of one or more of the various processors as the hardware structure, as described above.

### Explanation of References

1: digital camera
10: interchangeable lens
12: lens side mount
20: optical system
30: optical system driving unit
40: lens operation unit
50: lens microcomputer
51: processor
52: memory
100: camera body
102: camera-side mount
110: image sensor
120: shutter
122: shutter driving unit
130: storage unit
140: interface unit
150: rear surface monitor
170: camera operation unit
200: camera microcomputer
210: processor
210A: image data acquisition unit
210B: lens information acquisition unit
210C: pre-processing unit
210D: distance image data generation unit
210E: development treatment unit
210E1: white balance correction unit
210E2: gamma correction unit
210E3: demosaicing unit
210E4: YC conversion unit
210E5: contour/tone correction unit
211A: image data acquisition unit
211B: lens information acquisition unit
211C: correction setting information acquisition unit
211D: first pre-processing unit
211E: display image data generation unit
211F: second pre-processing unit
211G: distance image data generation unit
212A: image data acquisition unit
212B: lens information acquisition unit
212C: correction setting information acquisition unit
212D: first pre-processing unit
212E: display image data generation unit
212F: second pre-processing unit
212G: distance image data generation unit
212H: post-processing unit
213A: image data acquisition unit
213B: lens information acquisition unit
213C: correction setting information acquisition unit
213D: first pre-processing unit
213E: display image data generation unit
213F: second pre-processing unit
213G: distance image data generation unit
213H: post-processing unit
214A: image data acquisition unit
214B: lens information acquisition unit
214C: correction setting information acquisition unit
214D: first pre-processing unit
214E: display image data generation unit
214F: second pre-processing unit
214G: distance image data generation unit
214H: recording image data generation unit
214J: recording controller
220: memory
Di: distance image data
Di1: distance image data
Di2: distance image data
Im0: image data
Im1: image data
Im1a: image data
Im1b: image data
Im2: image data
Lv: display image data
S101 to S103: procedure of distance measurement
S201 to S210: procedure of processing of live view output and distance measurement
S301 to S310: processing procedure of output of live view
S401 to S410: processing procedure of output of live view
S501 to S506: procedure of processing in case of recording image data

What is claimed is:

1. An image data processing device comprising at least one processor,
wherein the processor is configured to:
acquire first image data captured through an optical system;
generate second image data from the first image data by correcting image quality degradation caused by the optical system; and
generate first distance image data from the second image data.

2. The image data processing device according to claim 1,
wherein the processor is configured to:
generate the second image data from the first image data by correcting image quality degradation that affects generation of the first distance image data among the image quality degradation caused by the optical system.

3. The image data processing device according to claim 1,
wherein the processor is configured to:
generate third image data from the first image data; and
output the third image data to a display destination or a recording destination.

4. The image data processing device according to claim 3,
wherein the processor is configured to: generate the third image data from the first image data by performing correction different from correction performed on the second image data.

5. The image data processing device according to claim 1,
wherein the processor is configured to:
generate fourth image data from the first image data;
output the fourth image data to a display destination or a recording destination;
generate second distance image data from the first distance image data by performing processing of reducing a difference generated between the first distance image data and the fourth image data; and
output the second distance image data to a display destination or a recording destination.

6. The image data processing device according to claim 1,
wherein the processor is configured to:
output the first distance image data to a display destination or a recording destination;
generate fifth image data from the first image data;
generate sixth image data from the fifth image data by performing processing of reducing a difference generated between the first distance image data and the fifth image data; and
output the sixth image data to a display destination or a recording destination.

7. The image data processing device according to claim 3,
wherein the processor is configured to:
output the second image data to a recording destination in association with the third image data.

8. The image data processing device according to claim 7,
wherein the processor is configured to:
output information used for generating the second image data to a recording destination in association with the second image data.

9. The image data processing device according to claim 1,
wherein the processor is configured to:
acquire first information including information necessary for correction of the image quality degradation caused by the optical system; and
generate the second image data based on the first information.

10. The image data processing device according to claim 9,
wherein the processor is configured to:
generate the second image data in a case where specific information among a plurality of pieces of information included in the first information is acquired.

11. The image data processing device according to claim 9,
wherein the processor is configured to:
restrict generation of the second image data in a case where the first information is not acquired.

12. The image data processing device according to claim 9,
wherein the processor is configured to:
generate the second image data based on second information specified in advance, in a case where the first information is not acquired; and
notify that the second image data is generated based on the second information.

13. The image data processing device according to claim 1,
wherein the processor is configured to:
generate the second image data by using one of components of the first image data or mixed image data in which the components are weighted.

14. The image data processing device according to claim 1,
wherein the processor is configured to:
generate the second image data by using a component that expresses luminance most effectively among the components of the first image data.

15. The image data processing device according to claim 1,
wherein the processor is configured to:
generate the second image data for each component of the first image data; and
generate the first distance image data for each component from the second image data for each component.

16. An image data processing method comprising:
acquiring first image data captured through an optical system;
generating second image data from the first image data by correcting image quality degradation caused by the optical system; and
generating first distance image data from the second image data.

17. A non-transitory, computer-readable tangible recording medium on which a program for causing a computer to execute the image data processing method according to claim 16 is recorded.

18. An imaging apparatus comprising:
an imaging unit that captures image data through an optical system; and
the image data processing device according to claim 1 that processes the image data captured by the imaging unit.

19. The imaging apparatus according to claim 18, further comprising:
a main body that includes the imaging unit and the image data processing device; and
an interchangeable lens that includes the optical system and is attachably and detachably mounted on the main body to be communicable with the main body,
wherein the processor is configured to:
acquire lens information from the interchangeable lens mounted on the main body; and
generate the second image data based on the lens information.

20. A learning device comprising at least one processor,
wherein the processor is configured to:
acquire a data set including image data for learning, which is captured through an optical system and of which image quality degradation caused by the optical system is corrected, and ground-truth data corresponding to the image data for learning; and
generate a model that outputs distance image data in a case where image data is input, by performing machine learning by using the data set.
